(19) United States
(12) Patent Application Publication
(10) Pub. No.: US 2003/0208493 A1
(43) Pub. Date: Nov. 6, 2003

(54) Object relational database management system

(76) Inventors: Bradley S. Hall, Concord, CA (US); Mark T. Lunetta, Berkeley, CA (US)

Correspondence Address: INTELLECTUAL PROPERTY LAW OFFICE, 1901 S. BASCOM AVENUE, SUITE 660, CAMPBELL, CA, 95008, US

(21) Appl. No.: 10/122,088

(22) Filed: Apr. 12, 2002

(51) Int. Cl. G06F 17/00

(52) U.S. Cl. 707/100

(57) ABSTRACT

An object relational database management system (DMS)(10) permitting a client application (16) to access one or more data sources (14). The client application (16) directs queries to an object server (ObjSvr) component (22), to obtain data from the data sources (14). The ObjSvr component (22) works with an object definition (ObjDef) component (20) to fulfill the queries. The ObjDef component (20) accesses an object ObjDef database (24) to obtain and use metadata (26), in the form of programmatic objects, about the location and structure of the data stored in the data sources (14). An optional object manager (ObjMgr) component (28) can work with the ObjDef component (20) to edit and create new metadata (26) or, via the ObjSvr component (22), to work with and create new instances of the data sources (14).

### CROSS-REFERENCE TO RELATED APPLICATIONS

This application claims the benefit of U.S. Provisional Application No. {pending}, by the same inventors and gaving the same title, filed Mar. 29, 2002.

### TECHNICAL FIELD

The present invention relates generally to systems used in database management, and more particularly to object relational databases.

### BACKGROUND ART

Conventional database systems have grown to be very powerful, but at the cost of also being very complex. Overwhelmingly, such database systems are difficult to use because the focus remains on the processes being used rather than on the underlying data and business relationships for that data. For example, current systems predominantly employ Structured Query Language (SQL).

Although very powerful, SQL is difficult to learn and use. There has been a strong movement to protect database developers and users from its complexities by using “high level” tools. Some current tools, for instance, employ a visual object metaphor. However, even within a single database platform, such tools are usually only able to access a subset of the actually available capabilities.

Across multiple database platforms, which are increasingly encountered in large organizations today, the situation is even more unfortunate. The presently available tools are, by in large, ones that work only with a single platform, or else ones that predominantly work with one preferred platform (usually very vendor specific and then intended to facilitate converting the data and rules of a few common other platforms to that one preferred platform). When it comes to actually using data relationships across multiple platforms, developers and users are left wanting.

These limitations in conventional database systems are not desirable. For organizations to migrate all of their database needs onto a single platform is often not practical. Organizations today often employ many diverse database platforms, albeit separately and with little synergistic benefit. These may also be platforms which organization management is aware of and has dictated the use of, or they may be platforms it are unaware of until in the process of data integration, when may are discovered and the true scope of the task appreciated. Another consideration is that the platforms encountered may be ones an organization does not control. Today, many organizations employ databases controlled by various governments, industry groups, and even competitors.

Organizations today often want to employ many different database platforms. Specialized database solutions are available for particular tasks, and adapting a general database platform to such tasks would be expensive and time consuming. Simply put, using an existing tool is better than creating an entirely new tool, but the problem here is getting all of the tools to work together. Furthermore, when tools do work together, there often is a synergistic result in addition to the aggregation of results. Organizations are increasingly finding this to also be the case with databases, and seeking this. Unfortunately, such organizations are then encountering the noted poverty of usable multiplatform database tools.

Accordingly, what is desirable now is a new database management system, one that works well with multiple, highly diverse data sources.

### DISCLOSURE OF INVENTION

Accordingly, it is an object of the present invention to provide a new database management system.

Briefly, one preferred embodiment of the present invention is an object relational database management system for a client application to access data in at least one data source. An object definition database, an object definition component, and an object server component, are provided. The object definition database contains metadata, in the form of programmatic objects, about location and structure of the data in the data sources. The object definition component reads the metadata from the object definition database and provides it to the object server component. The object server component manages data storage and retrieval functions in the data sources for the client application, based on the metadata.

An advantage of the present invention is that it does work well with multiple, highly diverse data sources.

Another advantage of the invention is that it may be implemented to have features including many or all of: object-based applications development, the use of virtual objects, true three-tier development, database independence, cross-platform data integration, flexible relational integrity, simplified data maintenance, modular legacy migration, a powerful business rules architecture, and the use of interface objects to provide inheritance.

And another advantage of the invention is that it separates data storage issues from user interface issues. The data in the invention may be stored in relational databases using existing relational database engines. This permits the creation of a middle layer or tier that organizes the data into business objects that are usable by front-end applications. The business objects may then more accurately reflect the way a user thinks of data, and thus correspond more closely with the way the user interface is developed. This eliminates the need for application developers to understand how and where the data is stored and to code SQL queries to retrieve the data in a format that can be linked to the front-end application.

These and other objects and advantages of the present invention will become clear to those skilled in the art in view of the description of the best presently known mode of carrying out the invention and the industrial applicability of the preferred embodiment as described herein and as illustrated in the several figures of the drawings.

### BRIEF DESCRIPTION OF THE DRAWINGS

The purposes and advantages of the present invention will be apparent from the following detailed description in conjunction with the appended figures of drawings in which:

FIG. 1 is a block diagram schematically depicting the inventive DMS in the larger context of a data environment;

FIG. 2 is a block diagram summarizing the major metadata contents of the ObjDef database of the invention;

FIG. 3 is a legend usable with the object models discussed in FIGS. 4-9;

FIG. 4 is a table of representative constants which may be used with the objects in FIG. 5 and FIGS. 6A-H;

FIG. 5 is a schematic diagram depicting an overview of an ObjDef object model for the ObjDef component of the invention;

FIGS. 6A-H collectively depict the objects in the ObjDef object model of the invention;

FIG. 7 is a table of representative constants which maybe used by the ObjSvr component of the invention;

FIG. 8 is a schematic diagram depicting an overview of an ObjSvr object model for the ObjSvr component of the invention;

FIGS. 9A-E collectively depict the objects in the ObjSvr object model of the invention;

FIG. 10 is a table of representative constants which may be used by the base control components of the invention;

FIG. 11 is a schematic diagram depicting an AppNavigator type base control of the invention;

FIG. 12 is a schematic diagram depicting a FormNavigator type base control of the invention; and

FIG. 13 is a schematic diagram depicting a collection type base control of the invention.

In the various figures of the drawings, like references are used to denote like or similar elements.

### BEST MODE FOR CARRYING OUT THE INVENTION

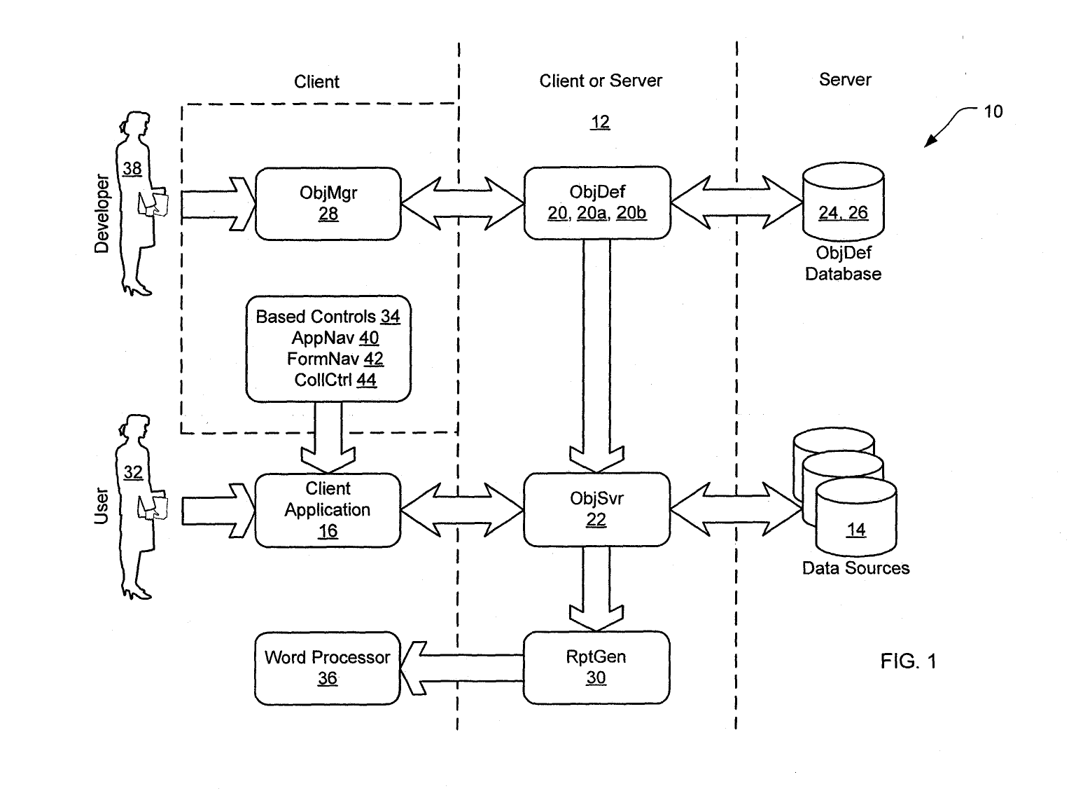

A preferred embodiment of the present invention is an object relational database management system (DMS). As illustrated in the various drawings herein, and particularly in the view of FIG. 1, this preferred embodiment of the invention is depicted by the general reference character 10.

FIG. 1 is a block diagram schematically depicting the inventive DMS 10 in the larger context of a data environment 12. The DMS 10 is generally interposed between one or more data sources 14 and one or more client applications 16 which need to work with data stored in the data sources 14. As such, the DMS 10 conceptually resides primarily in the middle of three tiers 18a-c. The major elements of the DMS 10 are an object definition component (ObjDef component 20), an object server component (ObjSvr component 22), and an object definition database (ObjDef database 24) of metadata 26.

FIG. 1 further depicts how the ObjDef component 20 and an object manager component (ObjMgr component 28) are responsible for defining and maintaining the ObjDef database 24 of metadata 26 associated with the data sources 14. The ObjSvr component 22 and a report generator (RptGen component 30) are then responsible for using the metadata 26 to store, retrieve, export, and report on data from the data sources 14, as requested by the client applications 16.

The first tier 18a in the data environment 12 includes a user 32 of the client application 16, the ObjMgr component 28, based controls 34, and a word processor 36. The first tier 18a also includes a developer 38, who works with the ObjMgr component 28. The middle or second tier 18b includes the ObjDef component 20, ObjSvr component 22, and RptGen component 30. The third tier 18c includes the data sources 14 and ObjDef database 24. The first tier 18a thus includes clients, the second tier 18b includes elements which can be either clients or servers, and the third tier 18c includes servers.

A number of the elements in this data environment 12 may be conventional or optional. Typically, there will be multiple data sources 14 present and they will be conventional, but neither of these is a requirement. As few as one data source 14 may be present and the ability to work with unconventional data sources 14 is merely a matter of providing additional appropriate functionality for this in the ObjSvr component 22. Once the principles of the invention are grasped, providing such functionality is a straight forward matter for those of reasonable skill in the programming arts.

In contrast, there typically will be only one client application 16 and it may be entirely conventional. This generally will be the case as a matter of convenience for the user 32. If the user 32 is human, it is anticipated that they will find working with just one client application 16 easiest to learn and use. If the user 32 is non-human, working with only one client application 16 reduces complexity. In fact, a major benefit of the DMS 10 is that it permits as little as one conventional client application 16 to be used with a plurality of highly diverse data sources 14. However, multiple client applications 16, conventional or otherwise, may be used if desired. For instance, a conventional client application 16 and an unconventional one might be used side by side to develop and refine the unconventional one.

The ObjDef component 20 and the ObjSvr component 22 are necessary elements of the DMS 10 and are not conventional. Accordingly, they will be the subjects of a considerable part of the discussion below, after these introductory paragraphs. The ObjDef database 24 is also necessary, and it is conventional in nature but not in its contents. It stores the metadata 26 used by the DMS 10 and, as such, it may simply be a database used to store data. As described presently, however, the metadata 26 itself is an aspect of the inventive DMS 10 which is novel.

The RptGen component 30 is optional. In most anticipated embodiments of the DMS 10 it will be provided, since it provides reporting capabilities that will often be desirable. It is non-conventional in that it works with the ObjSvr component 22, but otherwise it is straight forward and not unlike report components found in many existing applications. The RptGen component 30 produces an output which is readable and may be worked with by the word processor 36. The word processor 36 accordingly can be quite conventional, and in its simplest form may be merely a text display program.

The ObjMgr component 28 is also optional and non-conventional. In most anticipated embodiments of the DMS 10, the ObjMgr component 28 will be provided. It is what permits the developer 38 to interface with the DMS 10. Specifically, it allows the developer 38 to direct the ObjDef component 20 in forming appropriate metadata 26 for the ObjDef database 24.

The based controls 34 are optional utilities that work with the client applications 16 to particularly access additional capabilities which the DMS 10 provides. Three examples, are shown in FIG. 1: an application navigator (AppNavigator 40), a form navigator (FormNav 42), and a collection component (CollCtrl 44).

In summary, at its most basic level the DMS 10 works within the data environment 12 to permit a client application 16 to access data in a data source 14. To do this the DMS 10 particularly employs the ObjDef component 20, ObjSvr component 22, and ObjDef database 24.

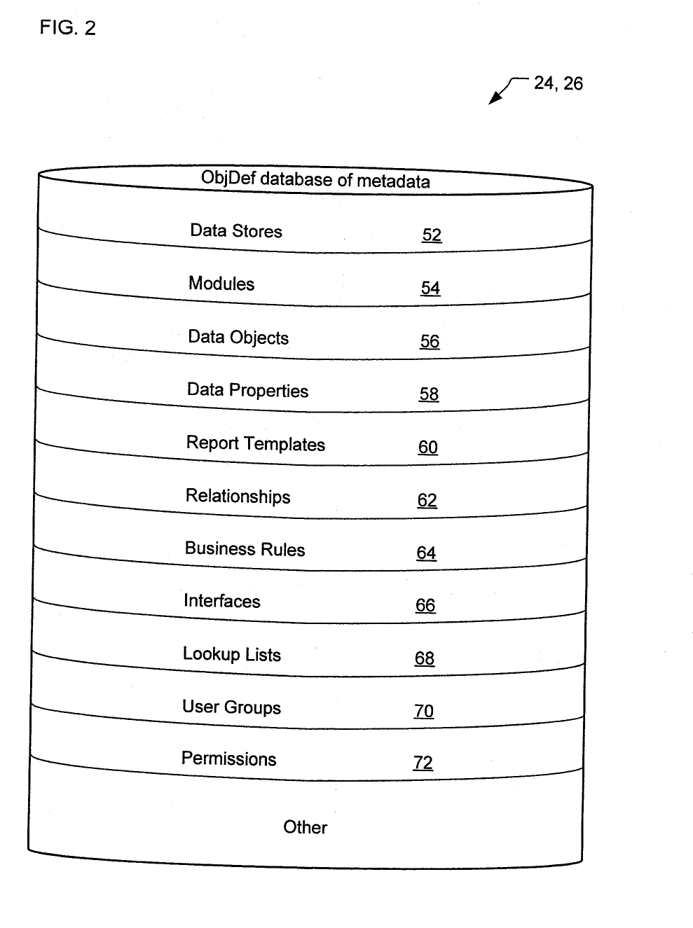

FIG. 2 is a block diagram summarizing the major contents of the ObjDef database 24. The ObjDef database 24 stores the metadata 26 about the various data sources 14 being managed. This includes both data storage and access information, as well as information on the way the data will be organized and used by the ObjSvr component 22. Specifically, the metadata 26 includes data stores 52, modules 54, data objects 56, data properties 58, report templates 60, relationships 62, business rules 64, interfaces 66, lookup lists 68, user groups 70, and permissions 72. The ObjDef database 24 is discussed further, presently.

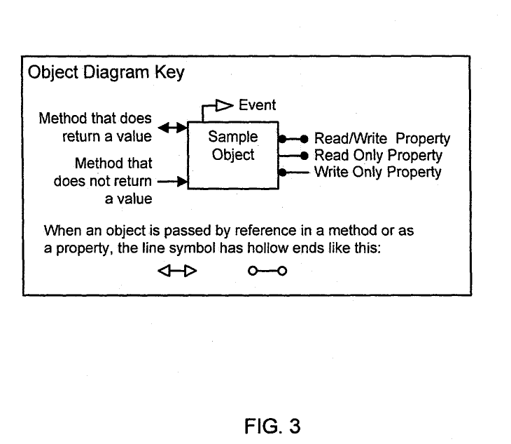

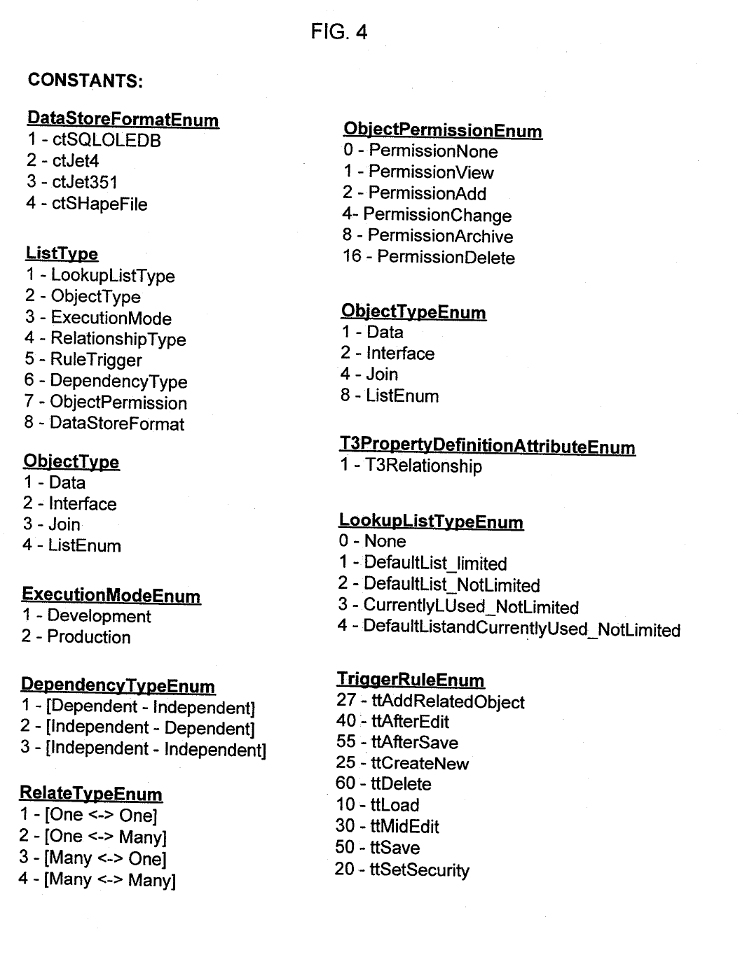

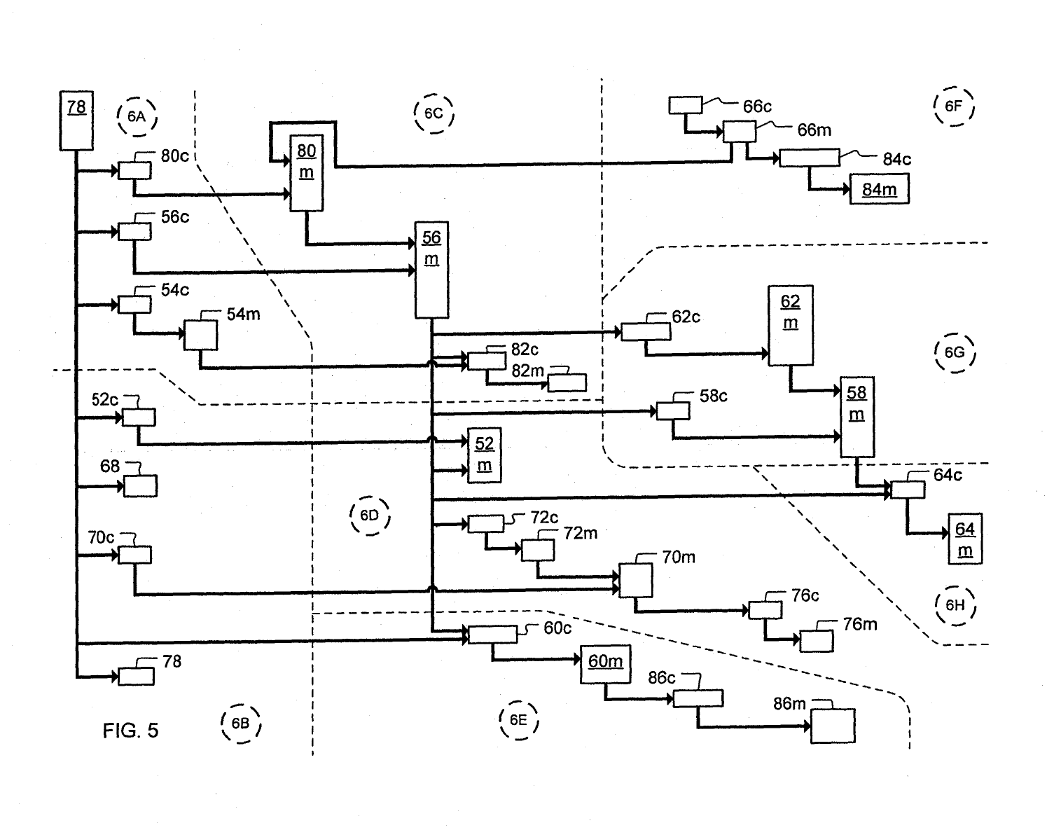

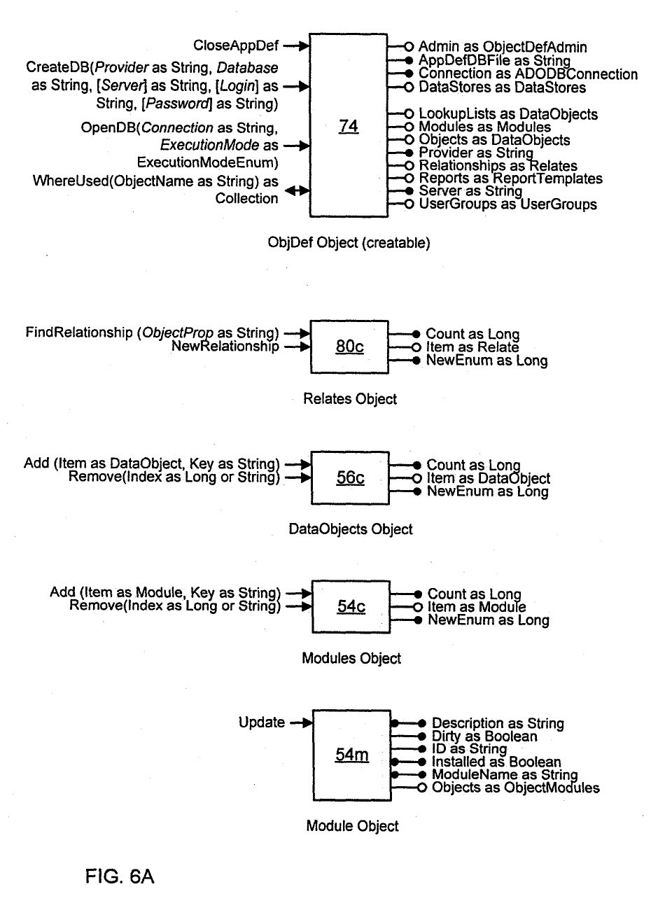

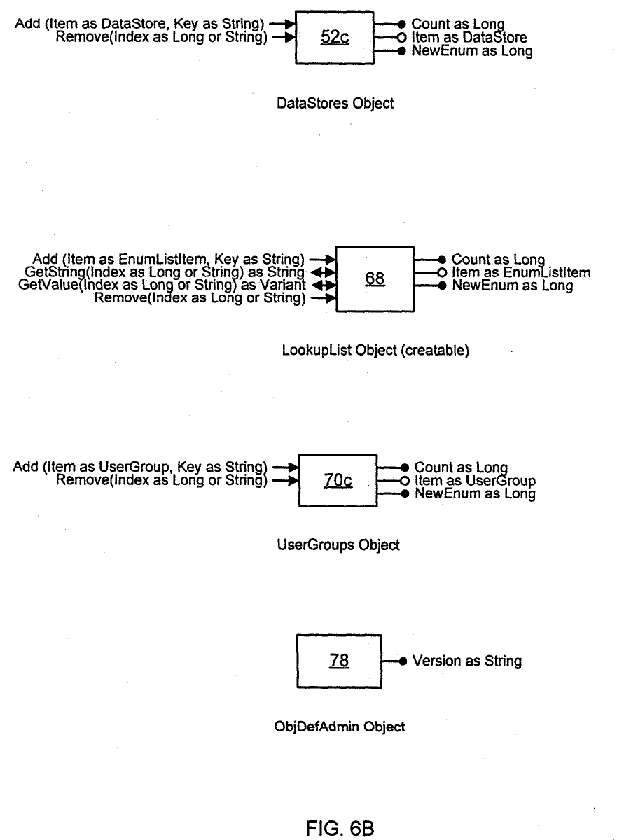

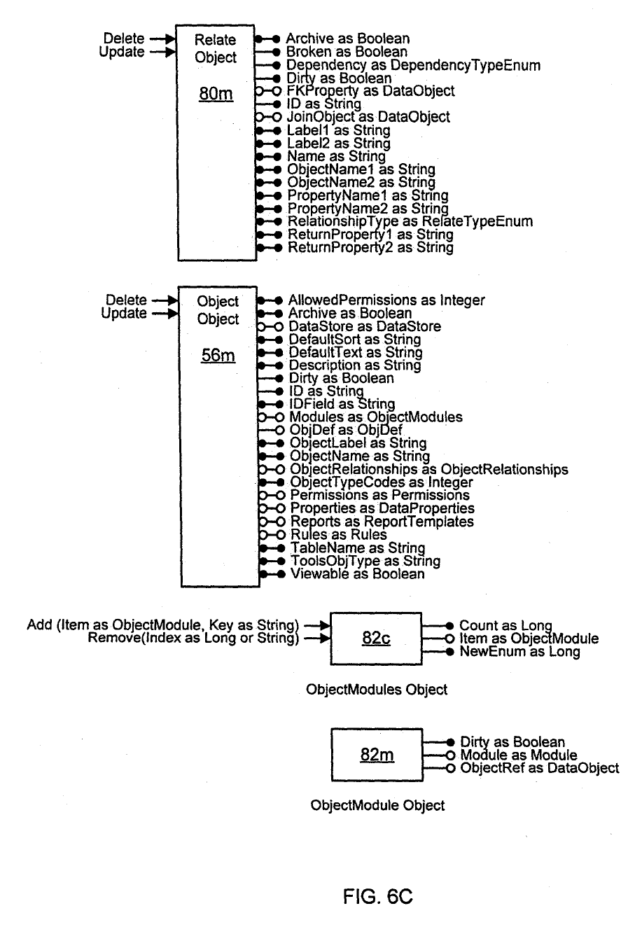

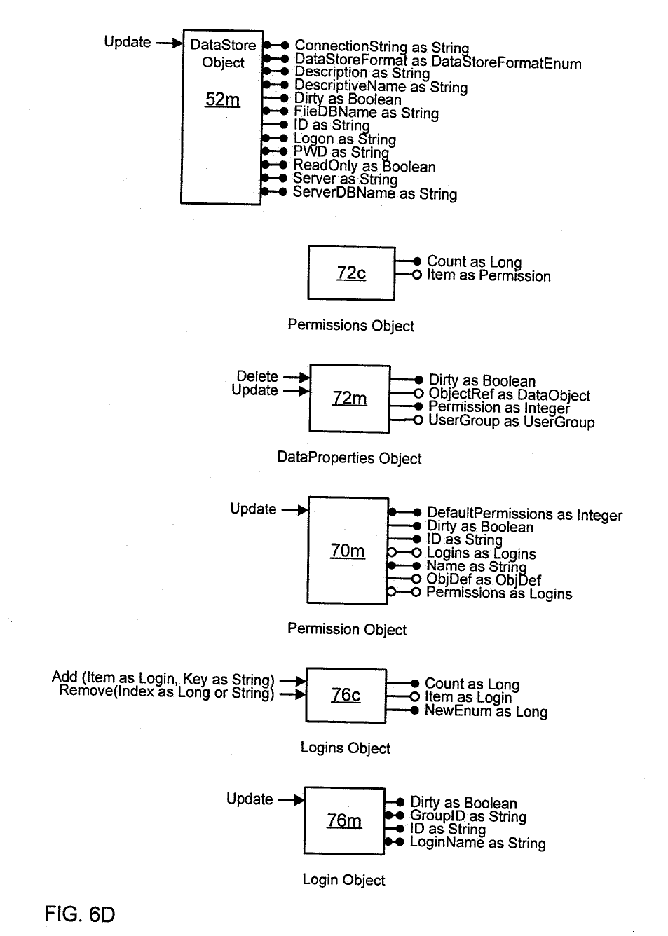

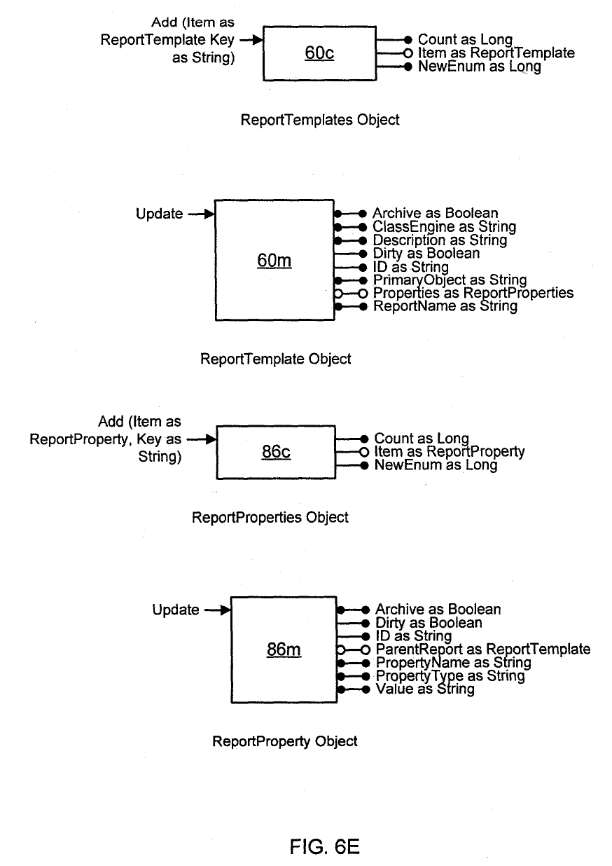

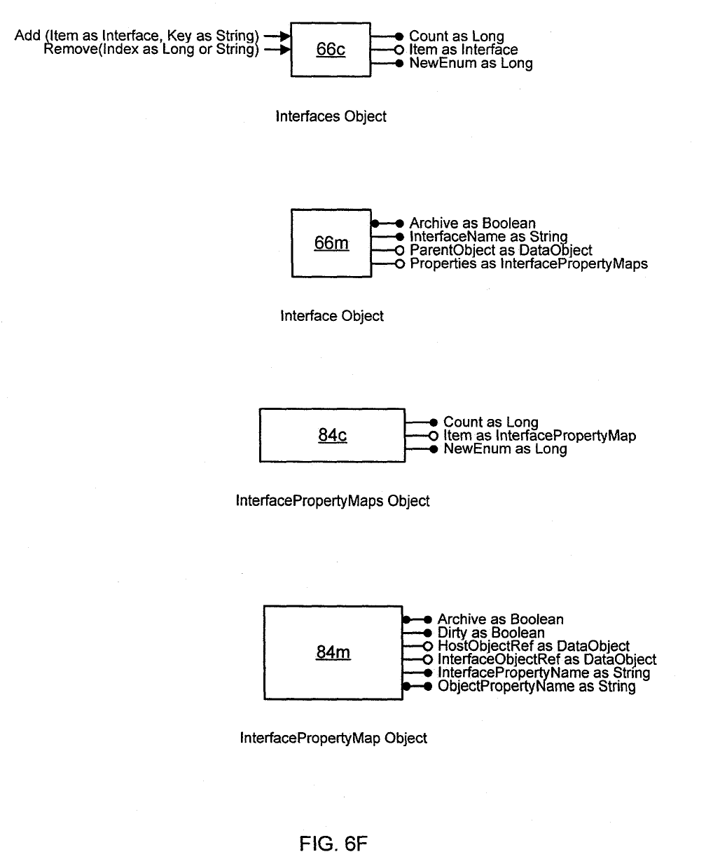

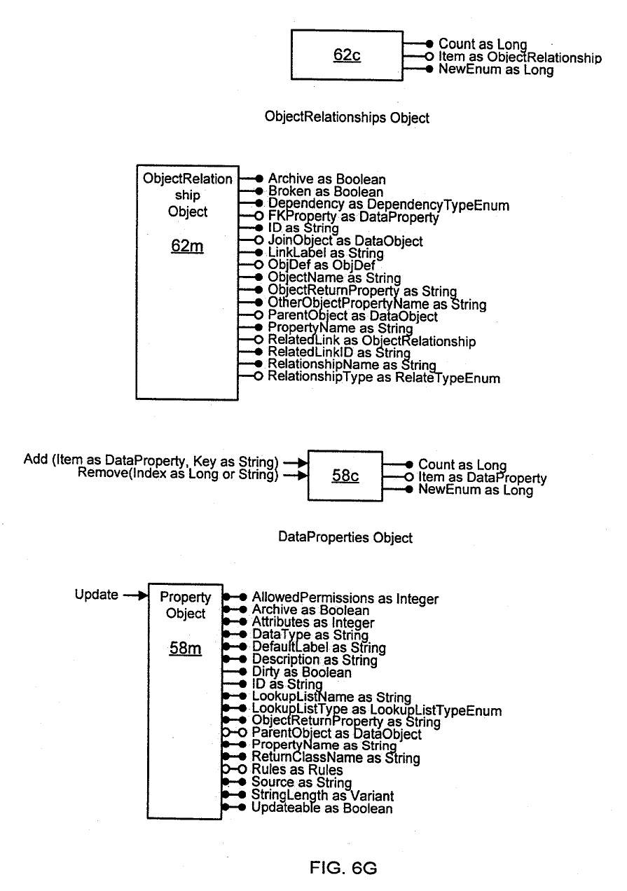

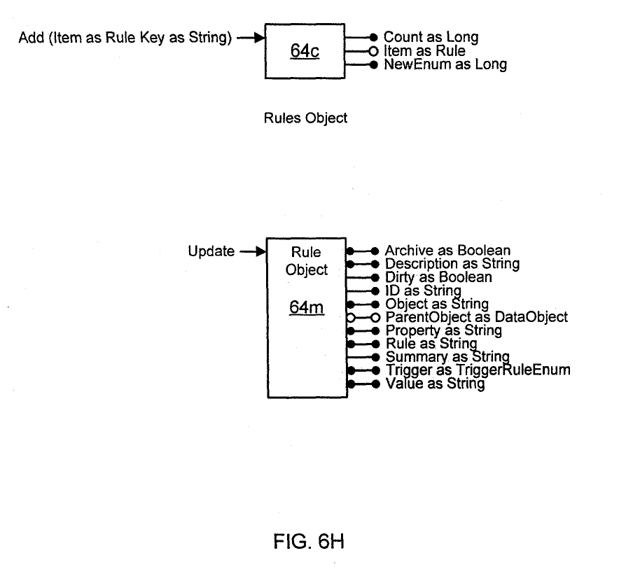

FIG. 3 is a legend usable with all of the object models discussed herein. FIG. 4 is a table of representative constants which may be used by the ObjDef component 20, and FIG. 5 and FIGS. 6A-H depict an ObjDef object model 50 for the ObjDef component 20.

The ObjDef component 20 and the ObjDef database 24 have a close relationship because they work together, and similar references have therefore been used here. To refer to these elements generically a simple format without suffixes is used; a “c” suffix is used when collections are specifically referenced; and a “m” suffix is used when members of a collection are specifically referenced. For example, consider the data stores 52. When this element is being referred to generally it is a “data store 52”; when referred to as a collection it is a “data stores 52c”; and when members of a collection are referred they are “data stores 52m.” Additional examples of this convention are found in FIGS. 6A-H.

The ObjDef component 20 is a component that works in conjunction with the ObjDef database 24 to provide the metadata 26 in a standardized format for use by the DMS 10. IN the preferred embodiment, the ObjDef component 20 is a single set of code compiled twice using a compile time switch, into two different server applications. An ObjDef version 20a is used in conjunction with the ObjSvr component 22 to read metadata from the ObjDef database 24 and provide it as programmatic objects to the ObjSvr component 22. This ObjDef version 20a does not have access to the “write” portions of the ObjDef object model 50 because that functionality is disabled by a compile time switch. An ODDev version 20b is used in conjunction with the ObjMgr component 28 to read and write the metadata to and from the ObjDef database 24. A detailed discussion of the ObjDef component 20 and the classes therein is provided, presently.

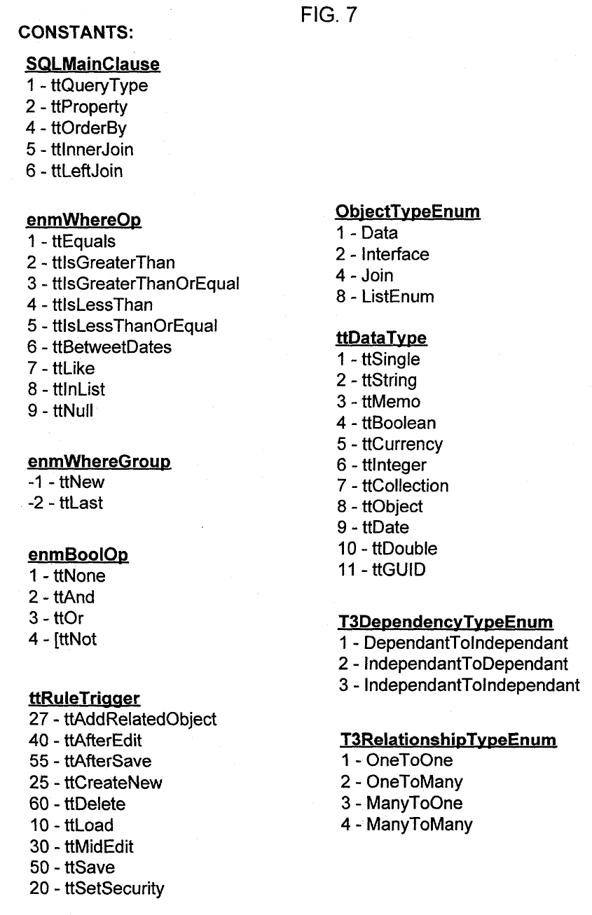

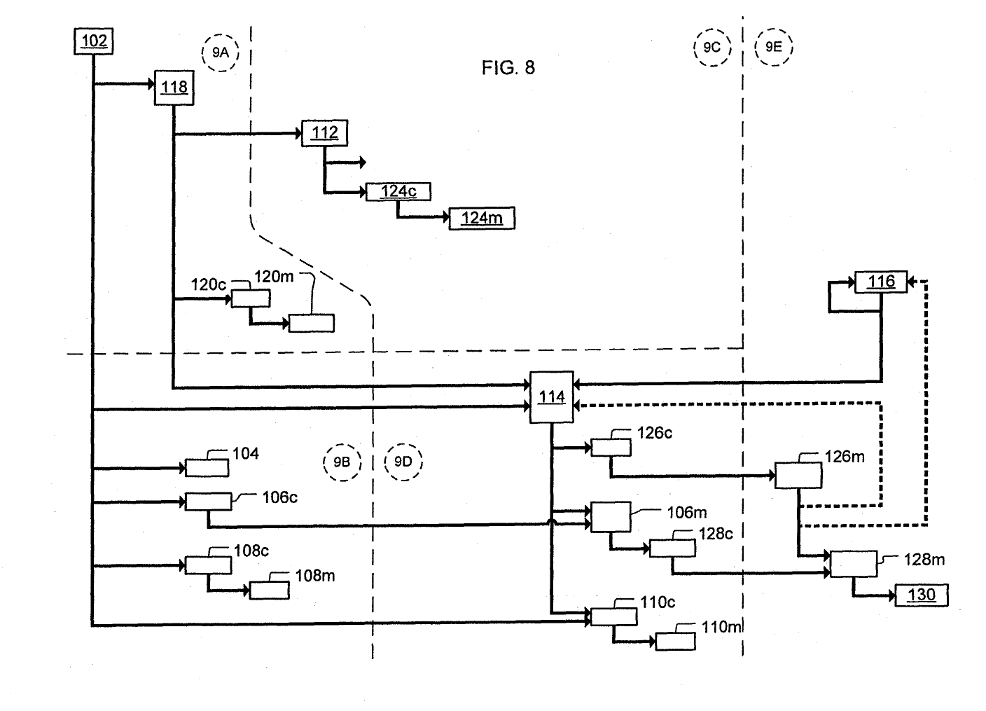

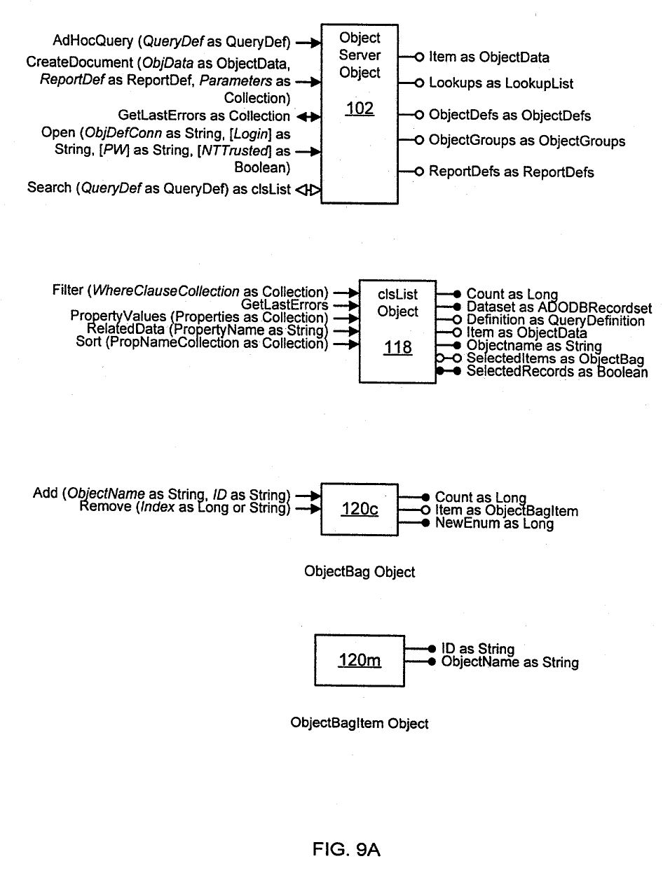

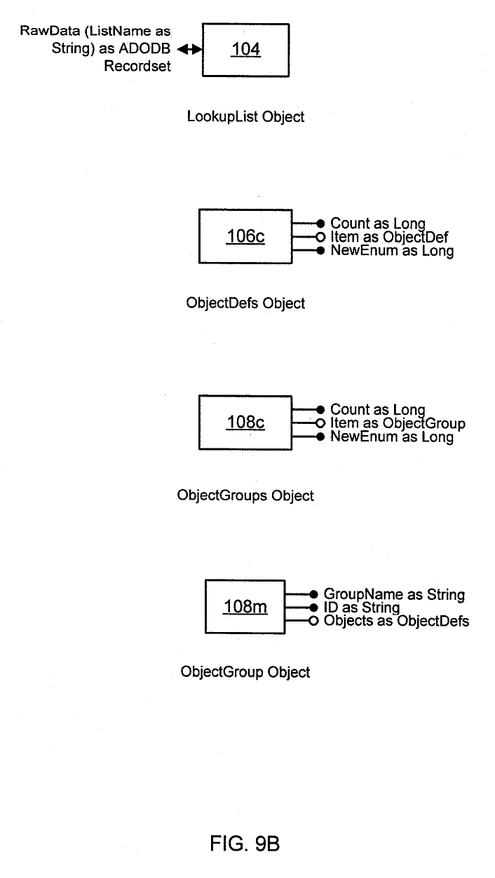

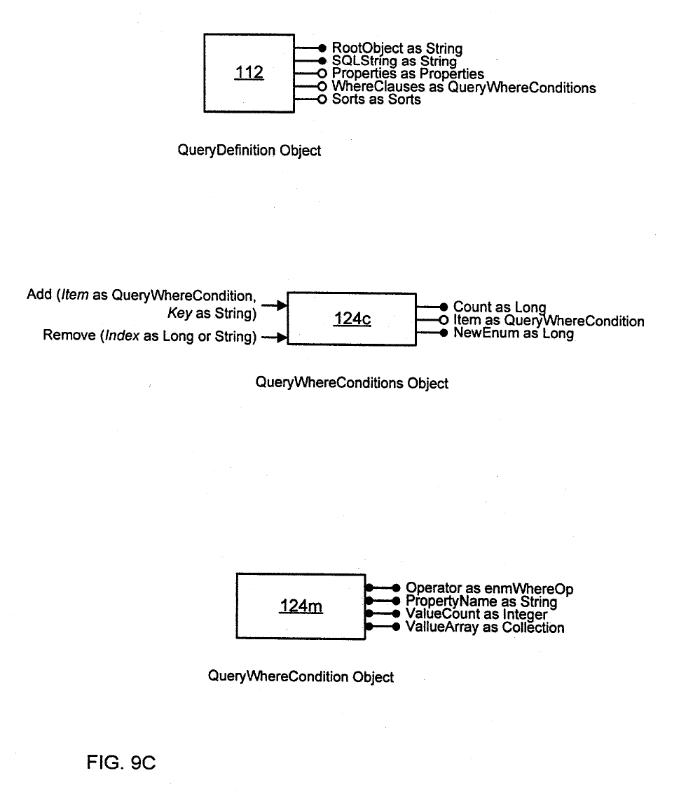

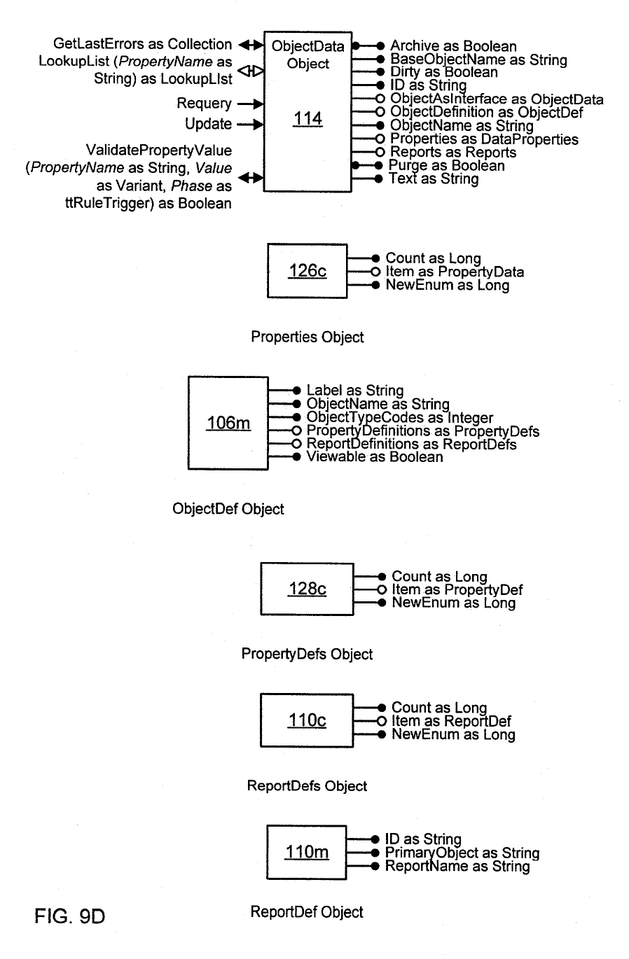

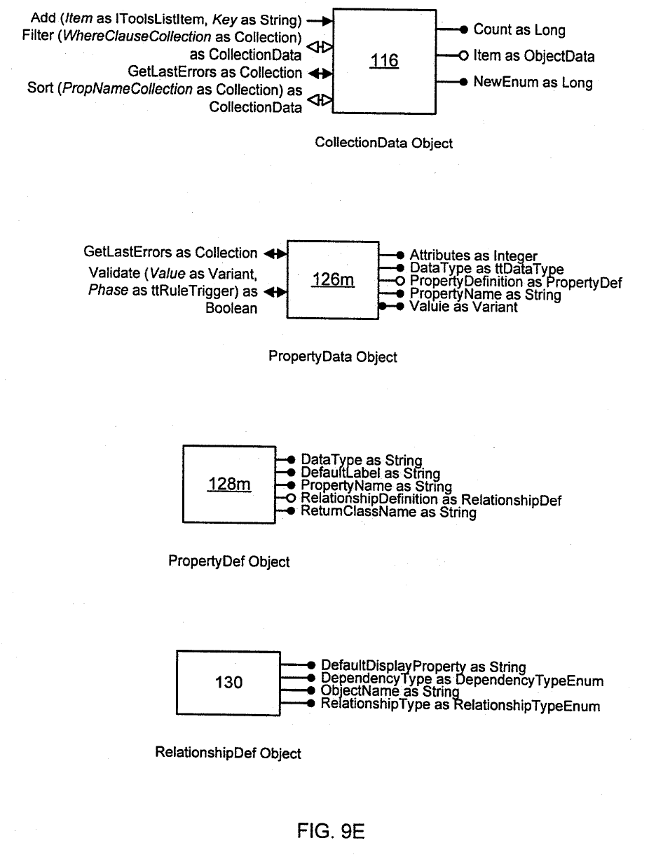

FIG. 7 is a table of representative constants which may be used by the ObjSvr component 22, and FIG. 8 and FIGS. 9A-E depict an ObjSvr object model 100 for the ObjSvr component 22. The ObjSvr component 22 is the heart of the DMS 10, being the link between the ObjDef component 20, client applications 16, data sources 14, and RptGen component 30. All data storage and retrieval functions are managed by the ObjSvr component 22. A detailed discussion of the ObjSvr component 22 and the classes therein is also provided presently.

In brief, when a client application 16 requests data from the data sources 14, the ObjSvr component 22 uses the metadata 26, provided by the ObjDef component 20, to determine the location of the desired data in the data sources 14, the structure which that data should be assembled into for presentation to the client application 16 (e.g., objects and properties), and any relationships between the subject data and other data elements in the data environment 12. The ObjSvr component 22 then queries the desired data from the appropriate target data source 14 or data sources 14 (plural)(e.g., databases or files), constructs an appropriate document, and then returns that document to the requesting client application 16.

When a client application 16 requests a report to be generated, the ObjSvr component 22 instantiates the RptGen component 30 and instructs it to generate the desired report. The ObjSvr component 22 then provides whatever data is requested by the RptGen component 30 during the creation of the report.

The data sources 14 are the data storage portions of the DMS 10. A variety of data sources 14 can be used within the DMS 10. Some example data sources 14, without limitation, include open database connectivity (ODBC) compliant databases, geographic information system (GIS) data files, and multimedia files.

ODBC compliant databases are well known in the data management arts (e.g., Microsoft ACCESS, ORACLE, and SQL SERVER). The inventor's present embodiment of the DMS 10 uses Microsoft's ActiveX Data objects (ADO) technology to access ODBC compliant relational databases. This version of the invention has been developed and tested against Microsoft SQL SERVER, Microsoft ACCESS, and DBASE IV format databases. ADO allows access to other relational database formats, each database system has slight variations with respect to the structure query language (SQL) used. Accordingly, new database formats can be added as needed after the variations have been identified and incorporated into the ObjSvr component 22 in the DMS 10.

Relational databases are extremely good at storing and retrieving data. The DMS 10 may therefore use only relational database systems for this purpose, but makes no use of relationship or business rule functionality in such database systems. The DMS 10 may use existing databases associated with other applications or new databases developed specifically for use with the DMS 10. If an existing relational database is connected into a data environment 12 employing the DMS 10, developers can either replicate the relationships and business rules or limit access to the relational database to view-only. Allowing editing or creating new access to such database could violate built-in data integrity rules if the rules are not replicated into the DMS 10.

GIS data files are not as widely known or used as ODBC databases, but they are quite useful. The DMS 10 can make use of GIS type data sources. For example, through the use of Earth Science Research Institute's (ESRI's) MAPOBJECTS LT control, the DMS 10 may display geographic maps and provide read-only access to data associated with map files.

Since its introduction by ESRI, the shape file has become the most widely used GIS file format. GIS coverages stored in shape file format are actually stored in multiple different files and the geographic entities are stored in the *.shp file. Each layer also includes a *.dbf (DBASE IV) format database file indexed to the entities in the *.shp file. The DMS 10 can work with shape file coverages in a read-only capacity, to use the MAPOBJECTS LT control for viewing shape file coverages and access the DBASE IV format databases directly using ODBC. Although ODBC allows read and write access to the database files, access may be limited to read-only to prevent corruption of the indexing data between the geographic entities and their associated database records.

Multimedia files are also well known in the computer arts, although their use with databases is not widely known. The increasing power of computers and the availability of digital recorders and converters have resulted in a significant increase in the quantity of electronic multimedia files that relate to traditional information stored in relational and non-relational databases. These files include electronic documents, emails, spreadsheets, photos, graphics, videos, and sound files. This information is typically stored as individual files in some form of user-friendly directory structure.

For example, the DMS 10 can also make use of a variety of multimedia files including image type files such as all common photo and raster-based graphic formats. Vector-based AutoCAD (*.dwg) files, as well as ACROBAT (*.pdf) files, and video (*.avi, *.mpeg, *.mov, etc.) files may be employed.

The DMS 10 treats a single directory root as a data source containing subdirectories and files. Each subdirectory under the root directory is defined as a single object and all files within a single subdirectory are expected to be of the same type. Thus, a directory or file structure is defined by a single data source 14 (root directory) with one or more object types (subdirectories) containing one or more object records (files). The DMS 10 can work with ASCII Text (*.txt), rich text (*.rtf), and Microsoft WORD (*.doc) document formats. It can work with Microsoft EXCEL (*.xls) format spreadsheets.

The ObjMgr component 28 is a graphical user interface (GUI) for the ODDev version 20b of the ObjDef component 20. This may be used to add, edit, and archive the metadata 26 stored in the ObjDef database 24. It is also used to create and modify the data structure of DMS-specific databases.

The RptGen component 30 works in conjunction with the ObjSvr component 22 to generate reports requested by the client applications 16. The inventor's present RptGen component 30 is actually a collection of report generators specifically designed to work with the DMS 10. Additional report generators can therefore be added as long as they support the interface used by the DMS 10.

The RptGen component 30 uses the Object.Property syntax defined in the ObjDef component 20 (discussed extensively, presently), combined with the report templates 60 to define the content and structure, respectively, of a report. Embedded within each report template 60 are Object.Property codes that signify the specific data elements to be placed into the report. When a report is generated, the Object.Property tags are replaced with data values from the data objects 56 supplied. The inventor's present RptGen component 30 works with report templates 60 in ASCII text, rich text, and MICROSOFT WORD formats.

When a report is requested by a client application 16, the ObjSvr component 22 reads the associated report definition information from the ObjDef database 24 (via the ObjDef component 20), identifies the location and format of the report template 60, instantiates the RptGen component 30, initiates the service (within the RptGen component 30) associated with the report format to be generated, and passes the requested report definition to the RptGen component 30. The RptGen component 30 then instantiates the application associated with the format of the report template 60 (ASCII Text and Rich Text formats are read directly by the RptGen component 30), loads the template file into the client application 16, extracts the content of the template from the file, reads the Object.Property tags included in the template, requests metadata 26 associated with each tag from the data sources 14 (via the ObjSvr component 22), replaces the tags with the returned metadata 26, inserts the resulting report back into the application from which the template was extracted, and displays the report (ASCII Text and Rich Text formats may be displayed within a text field in the client application 16 or in any email or text editing application specified in the template definition).

The client applications 16 are any code entity that either instantiates an ObjSvr component 22 or makes use of an existing instance of an ObjSvr component 22. The client applications 16 may be GUIs developed for human interaction or they may be interface-less programs serving other purposes. Any component object model (COM) compatible programming language can make use of the components of the DMS 10.

The DMS 10 has been developed around eight fundamental concepts. Each of these is now briefly described. The first to consider is the metadata 26. This is information about the location and structure of data stored in a database or other file format, i.e., in the data sources 14. The metadata 26 is also information about how the data in the data sources 14 should be organized for use by the client applications 16, how the data is related to other data (both within a single data source 14 and between data sources 14), what business rules 64 should be enforced relative to that data (for both data integrity and business practice purposes), and security issues for the data. The metadata 26 can also include general descriptive information regarding data sources 14 and their use that would not normally be managed by any data management system.

The metadata 26 is a key part of the DMS 10 because it services two very important functions. It allows a single, common ObjSvr component 22 to access an unlimited number of potentially quite different data sources 14 without any changes to the code within the ObjSvr component 22. It also allows changes to be made in the structure of the data sources 14 without changing the code that accesses it.

In a traditional software program for data management, access to data storage is managed through development of program code that explicitly matches the data storage structure. This means that the code includes explicit references to database tables, views, queries, and fields by name. Thus, if a table or view name changes or if a field name changes, the code must be changed to match. In addition, two users of the same application must have databases that match in structure or their versions of the software must be modified accordingly.

In the DMS 10, access to the data sources 14 is defined through the metadata 26 managed by the ObjDef component 20 and stored in the ObjDef database 24. The ObjSvr component 22 need have no knowledge of the data storage structure or have access until the storage structure and access specification are provided by the ObjDef component 20 at run-time. Thus, table or view names can change as needed and the only changes needed for the DMS 10 are metadata 26 changes in the ObjDef database 24. No code changes are required. In addition, multiple application users 32 can use the same client application 16 to work with data stored in different data sources 14 without any changes to the client application 16. The DMS 10 thus completely separates data storage structure from client application 16 coding.

The second fundamental concept of the DMS to consider is its use of Object.Property syntax. Object-oriented programming was first introduced into mainstream programming in the late 1980s. This style of programming is currently considered standard and is inherent in most modern programming languages (C++, VISUAL BASIC, JAVA, etc.). Although most programming languages are designed to be object-oriented, this does not mean that programmers have to write code that is object-oriented in its architecture. However, over the past decade, it has become common practice to design software that in an object-oriented structure.

In object-oriented programming a class is a prototype for an object. Thus, an object is a specific instance of a class. Each class will have associated properties and methods that represent the characteristics and actions of the object. Thus, an application may have class called Fish that is instantiated as a Trout object, a Salmon object, and a Tuna object. Traditional object-oriented development entails creation of code entities to represent each class to be used in an application. Complex data management systems will often involve hundreds of classes (code entities) to support all of the types of objects required by the system. Good code design will often make use of polymorphism or inheritance to reduce the amount of code required to define all of the necessary objects needed within the application. If object definitions change, the associated code entities must be changed accordingly.

In the DMS 10, four classes are implemented in code. The ObjectDef class is a programmatic entity used to hold the definition of an object. An object of this class holds a collection of PropertyDef class objects. The PropertyDef class is a programmatic entity used to hold the definition of a property associated with an object. The ObjectData class is a programmatic entity used to hold the data for an object. An object of this class holds a collection of PropertyData class objects. The PropertyData class is a programmatic entity used to hold the data for a property associated with the object. The ObjectDef-PropertyDef and ObjectData-PropertyData structures are parallel. The definition of an object is managed by the ObjDef component 20 and stored in the ObjDef database 24.

The way the DMS 10 works, assuming a client application 16 requests an object from the ObjSvr component 22, the ObjSvr component 22 retrieves the ObjectDef class object and associated PropertyDef class objects from the ObjDef component 20, instantiates an ObjectData class object and associated PropertyData class objects parallel to the structure represented by the ObjectDef and PropertyDef class objects, retrieves the metadata 26 from the data sources 14, populates the ObjectData and PropertyData class objects with the retrieved metadata 26, and returns the ObjectData and associated PropertyData class objects to the client application 16. The ObjectData and PropertyData class objects hold references to their corresponding ObjectDef and Propertydef class objects.

Provided below is an example of the differences between traditional coding and the approach of the DMS 10 relative to objects and properties.

As a comparison, lets assume one is developing an application to manage two types of data objects: person class objects and organization class objects. The person class object has three properties: name, address, and marital status. The organization class object has four properties: name, address, business type, and sales volume.

In a traditional application, the program code would have two classes to represent the two class objects. Each class would be named accordingly for use by the program. The person class would contain code associated with managing the three properties. Similarly the organization class would contain code associated with managing its four properties. The code for managing each property would specify the data type associated with the property (name would be a string, marital status might be Boolean, sales volume would be numeric, etc.). When run, the application would create a new instance of a specific class object when that object is needed. The application would explicitly instantiate the object based on the code written for that class object. When referencing the name property of the new object, the application code would look something like: MyOrganization.Name. Data type checking is handled implicitly by the data type defined for each property. The violation of a data type would return a system error that must be handled by the application.

In traditional object-oriented programming, because each entity is represented by a specific programmatic object, when running, each entity is managed as a unique object. In the DMS 10, each entity is represented by an object definition (ObjectDef and PropertyDef objects) and a parallel data storage structure (ObjectData and PropertyData objects). Thus, when running, each entity is managed as a standardized object holding the data for that entity.

For the same system as presented above, in the DMS 10, the ObjDef component 20 would hold two ObjectDef objects defining the structure for the Person and Organization object types. The ObjectDef object for the Person object type would hold three PropertyDef objects defining the structure of the three properties for that object type. Similarly, the ObjectDef object for the Organization object type would hold four PropertyDef objects defining the structure of the four properties for that object type. In run time, a specific instance of a Person object would be a ObjectData object holding three PropertyData objects. Similarly an instance of the Organization object would be a ObjectData object holding four PropertyData objects. The data type for each property is specified in the PropertyDef object that corresponds to each PropertyData object. Data type checking is handled explicitly by the ObjSvr component 22 based on the data type defined for each property. The violation of a data type would result in the ObjSvr component 22 triggering a system error that must be handled by the client application 16.

Referencing objects programmatically in the DMS 10 is slightly different from traditional object-oriented programming. Using the example above, a traditional object-oriented reference to the Name property an instance of a Person class object would look like: MyPerson.Name. This is accessing the Name property of the object represented by MyPerson. In the DMS 10, the same reference would look like: MyPerson.Properties(“Name”).Value. This would be accessing the Value property of the PropertyData object indexed as “Name” in the collection of properties in the ObejctData object represented by MyPerson.

Although programmatic referencing of objects is slightly more complicated than traditional Object.Property syntax, various portions of the invention make strong use of this syntax. For instance, this syntax is used in the ObjMgr component 28 when setting up business rules 64 and property inheritance through relationships 62. It is also used in the report templates 60 developed for the RptGen component 30.

Through the use of object relationships 62, one or more properties of a data object 56 can be another data object 56 or a collection (data objects 56c) of data objects 56m. Using the Object.Property syntax, reference can be made directly to a data property 58 of the “child” data object 56. An example of this would be a person data object 56 that has an organization data property 58. This data property 58 would hold an organization data object 56. If the name of the person's organization was desired for use on a report, the report template 60 might therefore use the following syntax: person.organization.name.

Within the ObjSvr component 22, the Object.Property syntax is exclusively used to refer to data managed by the DMS 10. Queries developed within the ObjSvr component 22 look similar to standard SQL with the exception that the table and field references are actually object and property references. This “object-based SQL” syntax implicitly defines joins through the use of the Object.Property syntax. Following the previous example, the reference to person.organization.name would implicitly include a join between the person data object 56 and the organization data object 56. The details of this join are defined in the metadata 26 for the relationship between the person data object 56 and the organization data object 56. Thus queries are initially created without any explicit knowledge of the relationships 62 between data objects 56. Once a query is prepared, before it is submitted to the underlying database engine of a data source 14 for processing, the ObjSvr component 22 converts the query from object-based SQL into traditional SQL. This involves replacement of the names for the data object 56 and data property 58 with respective table and field names and associated joins. If a query involves data objects 56 and data properties 58 from multiple data sources 14, separate queries are developed for each and the resulting data sets are merged within the ObjSvr component 22.

The third fundamental concept to consider is how the business rules 64 are implemented. Business rules can be divided into two general categories: data integrity rules and business process rules. Data integrity rules in the prior art are usually implemented in data sources and are designed to ensure that the data being stored there is consistent. Business process rules represent agreements on data content based on business process. Some examples of business process rules might include: required fields, valid data ranges, and auto-update or auto-notification on selected data changes. Business process rules in the prior art may be implemented within a data source but are often implemented in an application.

There are advantages and disadvantages to implementation of business rules in a data source versus an application. The business rules implemented in a data source are completely rigid and are always enforced by the data source. The business rules in an application can be extremely flexible depending on the needs of the business. If a new application is developed to make use of an existing data source, the business rules that exist in the data source will be evident and will be enforced regardless of the application accessing it. Any business rules that might exist in another application that works with that data source may not be known and will not be enforced unless they are recreated in the new application.

Implementation of a business rule 64 in the DMS 10 differs significantly from the prior art. In the DMS 10, all business rules 64, both for data integrity and business process, are administered within the ObjSvr component 22. This means that multiple client applications 16 can make use of the data sources 14, through the DMS 10, and have full compliance with the business rules 64 without having to recreate them for each client application 16. In addition, when the business rules 64 change, they are updated in the metadata 26 in the DMS 10 and are immediately enforced in all client applications 16.

Another difference in the approach of the DMS 10 is that the business rules 64 are far more flexible than has traditionally been possible. Because all business rules 64 are enforced in the DMS 10, the DMS 10 can change any of the business rules 64 based on operating parameters. As an example, required data is often enforced at the database level. Sometimes this is for data integrity reasons and others times it is simply a business process rule. Any rule enforced by the database is completely inflexible. In traditional development, if enforcement of the rule needs to be able to change based on a user's security access level, the rule would have to be implemented in the application. In the DMS 10, however, the rule, as a business rule 64, can be implemented as a conditional rule subject to a security level.

The fourth fundamental concept to consider is object-based security. Security in data management systems is usually implemented by both the applications and the databases. Database security then applies universally to all of the applications utilizing a database and is highly rigid. Application security, in contrast, varies between applications and is usually more flexible. Security is typically discussed with respect to permissions (i.e., what is permissible at a given security level).

Permissions managed by a database are usually based on a user's permission group, and this level of security applies to the entire database. There may also be another level of permissions set within the database at the table level, and this security level allows view, add, change, and delete records within the table.

Permissions managed by an application can be handled in a variety of ways, but are typically associated with a permission group, similar to the database permissions. Permissions set within a group can be more flexible than database permissions, however, and can apply to the database as a whole, to individual tables, to fields within a table, or to specific records based on specified conditions. Permissions managed by an application therefore can be very flexible, but will only apply to that application.

Similar to the implementation of the business rules 64, the DMS 10 implements security primarily within the ObjSvr component 22. The permissions 72 are established within the metadata 26 of the DMS 10 and are based on data objects 56 and data properties 58 rather than tables and fields defined in the data sources 14. This is done because the object and property structure established by the DMS 10 may not correlate directly to tables and fields in the data sources 14 and, thus, table level permissions there would not be effective or useful.

Because all permissions 72 are managed within the ObjSvr component 22, they can be extremely flexible as well as being conditional. The permissions 72 can be established on selected data objects 56 or selected properties and can be made to be conditional on system parameters (date, time, computer ID, etc.) or on data values (e.g., property 1 is view only until value of property 2 is set to true).

The fifth fundamental concept to consider is object-based relationships. The relationships 62 are links between different types of data. For example, people are related to organizations and tasks are related to projects. In traditional data management systems, relationships are usually explicitly defined within a database and are enforced as data integrity rules by the database. In some cases, the relationships are not explicitly defined in the database and must be managed by the application.

All relationships, including the relationships 62 of the DMS 10, fall into four basic types: 1-to-1, 1-to-many, many-to-1, or many-to-many. Relationships can be further refined through the use of cardinality (e.g., 0 or 1-to-1 and only 1, 0 or 1-to-0 or many, etc.) and relative dependency (Independent to Independent, Independent to Dependant, and Dependant to Independent). Cardinality and dependency are effectively business rules that act on relationships.

In the DMS 10 the relationships 62 are administered by the ObjSvr component 22 and are stored within the data sources 14 as either foreign keys within tables or as join tables. An example of a foreign key would be the storage of an organization ID in the record for a person. The organization ID correlates to the record ID for the related organization record. Join tables are used is all many-to-many relationship and may be used in other relationships. A join table typically holds two foreign keys. These keys are the record IDs for the two related records in other tables.

The use of a foreign key in a related table versus a join table is an implicit statement of dependency. For example, a person must be part of an organization (i.e., is a dependant of an organization), therefore, the organization ID can be held as a foreign key within the person table. If a person does not have to be part of an organization (i.e., is independent), the two record ID's keys should be held in a join table. Although the location of the foreign keys is an implicit statement of dependency, many databases do not enforce this dependency based on the foreign key locations.

The specific details of the relationships are part of the business process and different types of data may have multiple relationships with one another. An example of this would be the relationship between people and projects. A project will have a project manager (a person). It might also have a deputy project manager (a person), a contract manager (a person), and technical manager (a person).

The object-based relationships 62 used in the DMS 10 are similar to those traditionally defined in databases, but they are developed around links between the data property 58 of one data object 56 and the data property 58 of another data object 56. Because the data objects 56 and data properties 58 may not be directly related to tables and fields in the data sources 14, the relationships 62 traditionally managed in the data sources 14 may not be relevant to those needed for the DMS 10. In addition, relationships 62 may exist between data contained in different data sources 14 managed on different platforms. For these reasons, all of the relationships 62 are defined in the metadata 26 of the ObjDef component 20, stored in the ObjDef database 24 and administered by the ObjSvr component 22.

Administration of the relationships 62 in the ObjSvr component 22 also allows for the existence of parameterized relationships 62. A parameterized relationship 62 exists when a data object 56 holds a foreign key that may be related to more than one type of data object 56. For example, imagine a client application 16 designed to log telephone calls. Further assume that this client application 16 also manages information on clients and employees. If a customer calls in, the client application 16 creates a new Call data object 56 with a foreign key associated with the appropriate Customer data object 56. If an employee calls in, the client application 16 creates a new Call data object 56 with a foreign key associated with the appropriate Employee data object 56. From this example we can see that depending on the call data object 56, it may have a relationship 62 with Customers or with Employees. Knowledge of which type of relationship 62 is appropriate is contained within a data property 58 of the Call data object 56.

In the DMS 10, a relationship 62 is a distinct entity and is given a unique name. For example, the relationship 62 between a project and the project manager might be simply called “project manager.” A relationship 62 within the DMS 10 is defined by establishing the two data objects 56 to be related, identifying the type of relationship (1-to-1, 1-to-many, many-to-1, or many-to-many), the dependency (independent-to-independent, independent-to-dependant, dependant-to-independent; I-to-I, I-to-D, D-to-I), and the cardinality (O or many to 1 and only one, O or many to O or many, etc . . . ). Once this information is provided, the DMS 10 determines the optimal design for the relationship 62 (i.e., where the foreign keys should be located and whether a join table is required). The developer 38 has the ability to change to a non-optimal design if that is necessary to connect to an existing data source 14.

An important aspect of relationships 62 within the DMS 10 is the definition of object and collection data types commonly supported in data sources for data properties 58. The data properties 58 of a data object 56 include all of the intrinsic data types commonly supported in data sources as well as data types specific to the DMS 10 for objects and collections. The object data type is a data property 58 whose value is another data object 56. For example, a person may have a data property 58 called organization. This organization data property 58 is actually, the organization data object 56 that is related to the person. A collection data type is a data property 58 whose value is a collection (data object 56c) of related data objects 56m. For example, an organization may have a data property 58 called employees. The employees data property 58 is actually a collection (data object 56c) of person data objects 56m that are the employees of that organization. The definition of a relationship 62 between data objects 56 in the DMS 10 automatically results in the creation of object or collection data properties 58 within each of the data objects 56 being related. The names of the data properties 58 are specified by the developer 38 when the relationship 62 is created.

The use of object and collection data types is fundamental to the Object.Property syntax, discussed above. As an example, assume one has a Project data object 56. This Project data object 56 has a data property 58 for a Project Manager. This Project Manager data property 58 is actually a Person data object 56 defined by the Project Manager relationship 62 defined between the project and person data objects. The Person data object 56 has a data property 58 for Employer. This Employer data property 58 is actually an Organization data object 56 defined by the Employees relationship 62 between the Organization and Person data objects. Thus, if one needs to see the name of the organization employing the project manager working on a specific project, one can use the Object.Property syntax that would be “project.project manager.employer.name.” In retrieving data from the data sources 14 for this the ObjSvr component 22 will use the relationships 62 identified in the metadata 26 to convert this Object.Property string into a SQL statement with joins between the necessary data tables.

The sixth fundamental concept to consider is cross-platform relationships. Relationships are traditionally defined between tables and fields within a database. Relationships between data in separate databases are possible within larger database systems such as SQL SERVER, ORACLE, and DB2. Relationships between data in separate databases in different database platforms (e.g., SQL SERVER to ORACLE) has generally not been possible unless managed explicitly by an application.

Because the DMS 10 manages all the relationships 62 external to the data sources 14, and can connect with multiple data sources 14 on multiple database platforms, cross-platform relationships 62 are possible. This type of relationship 62 is defined in exactly the same way as any other relationship 62. Object-based queries involving cross-platform relationships 62 are generated and managed in the same way as any other query. When executing the query, the ObjSvr Component 22 creates separate SQL statements on each platform (data source 14) and integrates the results prior to delivery to the client application 16.

The seventh fundamental concept to consider is the use of interface objects. The interfaces 66 are objects that do not directly correlate to any data stored in the data sources 14. These objects are very similar to data objects 56 in that they have data properties 58. The key difference is that the properties of interfaces 66 are mapped to the data properties 58 of data objects 56. This is a form of inheritance. Any data object 56 that supports a specific interface 66 can be used wherever that interface 66 is used. The data object 56 will also inherit any relationships 62 that exist with the interfaces 66 that it implements. Multiple interfaces 66 can be implemented by a single object type.

The interfaces 66 are used within the DMS 10 to provide data inheritance. These objects are used in cases where multiple types of objects need to be combined within a single list or where different types of objects can be used interchangeably. An example would be a client application 16 for managing infrastructure assets for a storm water system. The system will likely have a variety of objects defined for fittings, valves, culverts, catch basins, outfalls, etc. . . . While each of these objects is different, at some level of granularity, they are all structures in the system. Thus, a request to view all of the structures of the system should result in a list of all of the object types that are structures. Alternatively, a request to view culverts should only result in the objects that are culverts. Implementation of a structure interface will allow all of the objects to be both their intrinsic type as well as a structure object.

The interfaces 66 are also useful when combining similar data objects 56 from multiple data sources 14. An example would be a system that is working with client data from two different data sources 14. The data from each would be defined as different data objects 56 that each implement a common interface 66. Thus, any client application 16 would see a single list without knowing where individual data elements originated.

With reference again to FIG. 2, a more detailed discussion of the major metadata 26 contents of the ObjDef database 24 is now provided. The metadata 26 includes data stores 52, modules 54, data objects 56, data properties 58, report templates 60, relationships 62, business rules 64, interfaces 66, lookup lists 68, user groups 70, and permissions 72. Although the metadata 26 in the ObjDef database 24 is not explicitly relational, it is preferably maintained in a relational type database for convenience. Each type of metadata 26 is stored in one or more tables within the ObjDef database 24.

It should be appreciated that all references to data properties 58, relationships 62, data objects 56, modules 54, etc. are stored as GUIDs in the ObjDef database 24 to all names to be changed without affecting other objects that use them. The ObjDef component 20 converts references between names and GUIDs as needed.

One of the most significant capabilities in the DMS 10 is its ability to integrate data contained in multiple disparate instances of the data sources 14. A data store 52 is a definition of a distinct data source 14 in which data is stored or retrieved. All of the information about the data stores 52 is maintained in a single table within the ObjDef database 24.

The specifications of the data store 52 may include the following types of information. Friendly name—a name that the DMS 10 uses to refer to the data store 52. This may be used in data objects 56 to refer to the data source 14 in which the data of a data object 56 is stored. Provider—a reference to the format of a data source 14. Some options here might include, without limitation, SQL SERVER 7.0, ORACLE 8.0, JET 3.5 1, JET 4.0, etc. Database name—the name of a data source 14. For server-based data sources 14 (e.g., SQL SERVER, ORACLE, DB2), this is the database name as it is managed within the data source 14 itself. For file-based data sources 14 (e.g., Microsoft ACCESS, DBASE, etc.), this is the file name and path for the database file. Server name—only used for data sources 14 that exist within a server-based database system (e.g., SQL SERVER, ORACLE, DB2). This refers to the name of the server on which the database is running. Login—the security login used to access the data within a data source 14. A blank in this field indicates that no logon is necessary. Password—directly related to the login. If no login is provided, no password is necessary. Read only—a flag that indicates whether the DMS 10 is allowed is make changes to data within a data source 14. Description—to hold notes about a data source 14. This is not used within the DMS 10 but is useful for a system administrator.

The modules 54 are used to group functionality and data objects 56 together for use by the client applications 16. The modules 54 typically are created to match departments or user groups who have interest in a subset of the functionality or data contained in the data sources 14. The data objects 56 can exist in multiple modules 54. The information about a module 54 is stored in two tables within the ObjDef database 24. One contains descriptive information for each module 54 and the second links the data objects 56 to modules 54.

The specifications of the module 54 include the following types of information. Module name—the name that a client application 16 uses to refer to the module 54. Installed—a flag that indicates whether the module 54 is enabled for use by a client application 16. A true value in this field indicates that the module 54 is installed. Description—used to hold notes about the module 54. This is not used within the DMS 10 but is useful for a system administrator. Object Name—a reference to the data objects 56 stored as Globally Unique Identifiers (GUIDs), that are to be included as part of the module 54. When a user 32 selects a module 54 in the user interface of a client application 16, only the specified data objects 56 are visible in the AppNavigator 40.

The data objects 56 are logical representations of physical or procedural objects related to the business being supported. All of the information for the data objects 56 is maintained in a single table within the ObjDef database 24.

The specifications of the data object 56 include the following types of information. Name—the name that is used to refer to the data object 56. It is used in any object or Object.Property reference. Label—a user-friendly name for the data object 56. It is only used to display the names of data objects 56 in the client application 16. Data store—a reference to the name of a specific data source 14 within which the data for the data object 56 is stored or retrieved. Table name—the name of the table in a data source 14 in which the data for the data object 56 is stored. Not all data objects 56 will have a corresponding table. ID field—a reference to the unique field within the table that holds the ID for each record. Default text—a reference to the default data property 58 that is used to populate data lists for the data object 56. Default sort—a reference to the property that is used as a default sort order when generating a data list for the data object 56. Archive—a Boolean value used to identify whether the data object 56 is enabled within the DMS 10. Viewable—a Boolean value used to identify whether the data object 56 is viewable and can have a corresponding display screen in a client application 16. Allowable permissions—a global set of permissions for all users 32 of the data object 56 (regardless of security permissions 72). The permissions here may include view, add, change, archive, and delete. Description—a field is used to hold notes about the data object 56. This is not used within the DMS 10 but is useful for a system administrator.

The data properties 58 represent data elements associated with data objects 56. A single data object 56 will contain a collection (data properties 58c) of data properties 58m. The data properties 58 are similar to fields in a conventional database table, but are far more flexible. It is possible to create data properties 58 that represent concatenations of other data properties 58, mathematical calculations, or data from properties in related data objects 56. All of the definition information for data properties 58 is maintained in a single table within the ObjDef database 24.

The specifications of the data property 58 include the following types of information. Object name—the name of a data object 56 to which the data property 58 applies. Property name—the name of the data property 58. Data type—the intrinsic type of data associated with the data property 58. This may include Boolean, collection, currency, date, double, integer, memo, object, single, string, and guid. Length—the allowable length if the data property 58 is of string type. Other types have no length value. Default label—the user-friendly text label that will be displayed for the data property 58 in any list of properties. Source—the definition of a data source 14. The sources here can include database, fields, related data objects 56, data properties 58 from a related data object 56, or concatenated values of data properties 58. (See the discussion of the fields in a data source 14, below.) Description—a field is used to hold notes about the data property 58. This is not used within the DMS 10 but is useful for a system administrator. Lookup list—since data properties 58 of string data type may contain values that are contained in a lookup list, this is a parameter set to the desired lookup list 68 or left blank. Lookup type—the behavior of the data property 58 related to a lookup list 68. (See the discussion of lookup types, below.) Archive—a Boolean value used to identify whether the data property 58 is enabled within the DMS 10. Allowable permissions—a global set of permissions for all users 32 of the data property 58 (regardless of security permissions 72). The permissions here are limited to view and change.

References to fields in a data source 14 are defined as the field name bounded by square brackets “[ ].” For example, “[First_Name].” Related data items (applicable to objects and collections) are defined as the name of the relationship 62 bounded by curly brackets “{ }”. For example, “{OrganizationPeople}.” The data properties 58 of related data items are defined as the property name for the related object followed by a period (“.”) and the desired property name from the related object. For example, to display an organization name for a person (where “OrganizationObject” is a property in the person), the source would be “OrganizationObject.OrganizationName.” If desired, the Object.Property syntax can be used to define sources that are several relationships apart (e.g., object.property.property.property, etc.). Concatenated values are defined as one or more names of data properties 58 combined together or with explicit strings using mathematic operators. Explicit strings are bounded by single quotes. For example, “LastName+′, ′+FirstName” would take two values of data properties 58, such as “John” and “Smith,” and create a new property with a value of “Smith, John.” All object and property references are stored in the ObjDef database 24 as GUIDs and are converted to and from user friendly names by the ObjDef component 20.

The lookup types, introduced above, may be as follows. None—for when no lookup list 68 is provided for the data property 58. Default list, limited—to provide the client application 16 with a default lookup list 68 of values and only allow entry or selection of a value contained there in. Default list, not limited—to provide a default lookup list 68 of values and allow entry or selection of a value contained there in, or any other value desired. Currently used, not limited—to provide the client application 16 with a lookup list 68 of distinct values compiled from all values currently used by this data property 58 in the ObjDef database 24. This allows entry or selection of a value contained in the lookup list 68 or any other value desired. Default list and currently used, not limited—to provide the client application 16 with a list of distinct values compiled from the default list (defined in a lookup list 68) of all values currently used by this data property 58 in the ObjDef database 24. This allows entry or selection of a value contained in the lookup list or any other value desired.

The DMS 10 utilizes the RptGen component 30 to generate reports as required by the user 32. Accordingly, the report templates 60 are defined and are each associated with a primary type data object 56. When a data object 56 is viewed in a client application 16, the associated reports are made available for use. When the user 32 requests a report, the RptGen component 30 is initiated by the ObjSvr component 22 and provided with the necessary data to create the report.

The specifications of the report template 60 include the following types of information. Object—the name of a data object 56 to which the report template 60 is associated. This must conform to an existing data object 56. Report name—the name of the report template 60 (i.e., of the report) that will be provided to the client application 16. Document type—the name of a document server within the RptGen component 30 that will be used to create the report.

The relationships 62 define the properties and parameters that link the data objects 56. The relationships 62 are defined between two data objects 56. Each side of the relationship 62 (data object 56) has an associated object or collection property, label, and object return property. The types of relationships 62 include 1-to-1, 1-to-many, or many-to-many. The dependencies of the relationships 62 include independent-to-independent and independent-to-dependant (I-to-I and I-to-D). Once a relationship 62 is defined, the properties created as part of the relationship 62 will be visible as data properties 58 of each of the data objects 56.

The specifications for the relationship 62 include the following types of information. Name—the name of the relationship 62. Object 1 name—the name of the first data object 56 in the relationship 62. This must conform to an existing data object 56. Object 1 property—the name of a data property 58 that will be created in the Object 1 that will hold the reference to the Object 2. For example, when creating a relationship between organizations and people, the property name in an organization type data object 56 may be “PeopleCollection.” Object 1 default label—the user-friendly label that will be displayed for the object 1 property. Following the previous example, the default label might be “People.” Object 1 return property—the data property 58, from Object 2, that is provided as default text in any display of the object 1 property. Relationship type—the type of relationship 62 between object 1 and object 2. Valid types include one-to-one, one-to-many (either direction), and many-to-many. Dependency—the dependency rule between object 1 and object 2. Valid dependencies include independent-to-independent (I-to-I) and independent-to-dependant (I-to-D or D-to-I). (See discussion of the dependency types, below.) Object 2 name—the name of the second data object 56 in a relationship 62. This must conform to an existing data object 56. Object 2 property—the name of a data property 58 that will be created in object 2 that will hold the reference to object 1. For example, when creating a relationship 62 between organizations and people, the property name in the person type data object 56 may be “OrganizationObject.” Object 2 default label—the user-friendly label that will be displayed for the data property 58 of the object 2. Following the previous example, the default label might be “Organization.” Object 2 return property—the data property 58, from object 1, that is provided as default text in any display of the data property 58 of object 2.

An I-to-I type relationship 62 means that the data objects 56 on either side of the relationship 62 can exist independent of the other. The default structure for this would be a separate join table that is used to maintain the relationship 62. Adding or removing data objects 56 on either side of the relationship 62 would add or remove records from the associated join table. When mapping to existing data sources 14, a foreign key can be located in one of the two tables. Adding or removing data objects 56 on either side would either eliminate the record with the foreign key or clear the value in the foreign key.

An I-to-D or D-to-I type relationship 62 means that the data object 56 or data objects 56 (plural) on the dependant side of the relationship 62 cannot exist without the independent data objects 56. For one-to-one and many-to-many type relationships 62, this means that a separate join table exists to maintain the relationship 62. For a one-to-many type relationship 62, the foreign key value is held within the data object 56 on the many side of the relationship 62.

The business rules 64 define the behavior of the DMS 10 with respect to data integrity, data validation, and system automation. The business rules 64 apply to data objects 56 or data properties 58 and are triggered by events related to either. A target data object 56 or data property 58 of a business rule 64 is not necessarily the same as the trigger data object 56 or data property 58. The business rules 64 are applied when an action occurs on a trigger data object 56 or data property 58. This fires an event which forces execution of the applicable business rules 64. The business rules 64 are then interpreted and enacted appropriately.

The specifications of the business rule 64 include the following types of information. Object—the name of a data object 56 for which the trigger event is associated. This must conform to an existing data object 56. Property—the name of a data property 58 for which the trigger event is associated. This also must conform to an existing data property 58. If a data property 58 is not specified, the business rule 64 applies to the data object 56 only. Trigger—the type of event that triggers the business rule 64. Valid events include: load, set security, create new, add related object, mid edit, after edit, save, after save, and delete. Rule—the type of business rule 64 to be applied when the trigger is fired. (See the discussion of types of the business rules 64, below.) Value—the specified value associated with a business rule 64. This may contain simple values (true, false, number, text) or it may contain an expression to be evaluated. Description—the user friendly message or description returned to the client application when the business rule 64 is violated.

The inventors have currently developed business rules 64 including the following types. Comparison—performs a designated action if the result of the comparison is true. SetProperty—sets the target data property 58 to the designated value when triggered. Required—prevents saving if the value for a target data property 58 is not provided. This provides a message to the user 32. AddCollectionItem—adds designated data objects 56 to a designated collection when the trigger is fired.

The interfaces 66 are objects whose properties can be mapped to one or more data objects 56. The interfaces 66 can be used in any situation where a data object 56 would be used. The interfaces 66 contain data properties 58 and relationships 62 but do not hold or persist data. Any references made to an interface 66 pass directly through to the data object 56 referenced by it. Each data object 56 that is expected to be represented by an interface 66 must have an interface mapping for its data properties 58. An interface mapping is a mapping of data properties 58 within the data object 56 to each data property 58 of the interface 66. A data object 56 can have more data properties 58 than an interface 66, but an interface 66 cannot have more data properties 58 than an associated data object 56. All data properties 58 of the interface 66 must have an associated data property 58 in the data object 56.

The specifications of the interface 66 include the following types of information. Name—the name that is used to refer to the interface 66. It can be used in any data object 56 or Object.Property reference. Label—a user-friendly name for the interface 66. It is only used to display object names in a client application 16. Default text—a reference to a default data property 58 that is used to populate data lists for the interface 66. Default sort—a reference to a data property 58 that is used as a default sort order when generating a data list for the interface 66. Archive—a Boolean value used to identify whether the interface 66 is enabled within the DMS 10. Description—a field is used to hold notes about the interface 66. This is not used within the DMS 10 but is useful for a system administrator.

The lookup lists 68 are specialized objects that provide lists of values. They are used to populate drop-down lists and to help to ensure consistency in data entry. The specifications of the lookup list 68 include the following types of information. Name—the name of the lookup list 68. All lookup list objects have the following three properties. Code—a short form version of the lookup value. This is often an acronym or contraction. Description—a long form version of the lookup value. Definition—A extended definition of a lookup value.

Security is an extremely important part of any system. It is desirable to be highly flexible without being overly obtrusive in a client application 16. In the inventor's presently preferred embodiment of the DMS 10, security is implemented using WINDOWS NT type security logons combined with the user groups 70. Use of this NT logon approach allows the DMS 10 to set permissions based on the entity logged onto a computer. This means that no user specific logon is required unless a different entity is using the system than the entity who logged onto the computer.

Each logon is associated with a user group 70. The user groups 70 have specific security access permissions 72 for each data object 56 defined in the DMS 10. Higher permissions 72 can be provided on an as-needed basis using a security override from a user 32 with a higher permission 72. The permissions 72 are set for each user group 70 and each data object 56 for the functions: view, add, change, archive, and delete.

The specifications for the permission 72 include the following types of information. Object—the name of a data object 56 to which the permission 72 is associated. This must conform to an existing data object 56. Group Name—the name of a user group 70. View—this identifies if the specified user group 70 has a view type permission 72 (allowing its users 32 to see data). Add—this identifies if the specified user group 70 has an add type permission 72 (allowing its users 32 to create new data objects 56 of a designated type). Change—this identifies if the specified user group 70 has a change type permission 72 (allowing its users 32 to change data in an existing data object 56). Archive—this identifies if the specified user group 70 has an archive type permission 72 (allowing its users 32 to archive data objects 56 of a designated type). Archiving the data objects 56 does not remove them from the data source 14. It only flags them so that they are not displayed unless specifically requested. Delete—this identifies if the specified user group 70 has a delete type permission 72 (allowing its users 32 to delete data objects 56 of a designated type). The deleted data objects 56 are permanently removed from the data source 14.

This discussion now turns to the object models used in the inventive DMS 10. FIG. 3 is a legend which may be used with all of the object models presented herein. It is self explanatory. FIG. 4, is a table of representative constants which may be used with the objects in FIG. 5 and FIGS. 6A-H. FIG. 5 is a schematic diagram depicting an overview of the ObjDef object model 50 for the ObjDef component 20, while FIGS. 6A-H collectively depict the objects in the ObjDef object model 50.

After the discussion of the ObjDef database 24, above, it can be seen that the ObjDef component 20 is quite closely related to the ObjDef database 24. Many of the objects in the ObjDef object model 50 closely match the metadata 26 stored in the ObjDef database 24. These objects have methods that add, remove, change, access, etc. the metadata 26 and when they return properties they return elements of the metadata 26. As previously noted, the ObjDef component 20 and the ObjDef database 24 are so similar that similar references have been used. There are, however, also elements of the ObjDef component 20 that are not present in the ObjDef database 24. These elements are present at run-time, and they are now introduced as all of the elements of the ObjDef component 20 are discussed.

The ObjDef component 20 is a single set of code, compiled twice, using a compile time switch, into two different server applications, the ObjDef version 20a and the ODDev version 20b. The ObjDef version 20a is used in conjunction with the ObjSvr component 22 to read the metadata 26 from the ObjDef database 24 and to provide this as programmatic objects to the ObjSvr component 22. The ObjDef version 20a does not have access to the “write” portions of the ObjDef object model 50, since this functionality is disabled by the compile time switch. The ODDev version 20b is used in conjunction with the ObjMgr component 28 to read and write the metadata 26 to and from the ObjDef database 24.

The objects described next generally have some or all of the following properties and methods. An archive property returns a Boolean value indicating whether the relationship has been archived. Archived objects are not used by the DMS 10 and are not visible in the ObjDef component 20 when running in a production mode. A description property contains a text explanation of the object under discussion. A dirty property contains a value indicating whether the object under discussion has been changed since the last update. An ID property contains the unique identifier for the object under discussion. A name property contains a string value that is the name of the object under discussion. An ObjDef property returns a reference to a root ObjDef object 74 (described below). A delete method deletes the current instance of the object under discussion. And an update method saves any changes that have been made to the current instance of the object under discussion.

Similarly, the collections described next generally have some or all of the following properties and methods. A count property returns a value representing the number of members within the collection under discussion. An item property returns a specific member of the collection under discussion, either by position or by key. A NewEnum property allows support for “For Each . . . Next” style loops through the members of the collection. An add method adds a member to the collection. And a remove method removes a member from the collection.

A data store 52m is a definition of a distinct data source 14 in which data is stored or retrieved. In addition to the properties inherited through implementation of the programmatic iObjDefEntity (see interface 66m described below), the data store 52m has description, dirty, and ID properties and an update method. It further has the following properties. A ConnectionString property contains the information used to establish a connection to a data source 14. The DMS 10 supports four arguments for the ConnectionString property; any other arguments pass directly to the provider without any processing by DMS 10. The arguments supported are: Provider, to specify the name of a provider to use for the connection; File Name, to specify the name of a provider-specific file (for example, a persisted data source object) containing preset connection information; Remote Provider, to specify the name of a provider to use when opening a client-side connection; and Remote Server, to specify the path name of the sever to use when opening a client-side connection. A DataStoreFormat property contains a value that represents the storage format of the data store 52m. A DescriptiveName property contains a descriptive name for the data store 52m. A FileDBName property contains the file name for the data store 52m. This property is only used for file server databases (Microsoft ACCESS, DBASE, etc.), to contain the file name and path for the database file. For client server databases, this property is ignored. A logon property contains the logon used by the DMS 10 to access the current data store 52m. A PWD property contains the password used by the DMS 10 to access the current data store 52m. A ReadOnly property returns or sets a value indicating whether the data in the data store 52m can be changed by the DMS 10. A server property contains the name of the server that is managing the current data store 52m. This value is only used for client-server type data stores 52m. For file-server data stores 52m this property is ignored. Finally, a ServerDBName property contains the database name for the current data store 52m. This property is only used for client-server databases (SQL SERVER, ORACLE, DB2, etc.). For file-server databases, this property is ignored.

The data stores 52c is a collection class used to hold all of the definitions of the data stores 52m within the ObjDef component 20. It has count, item, and NewEnum properties and add and remove methods.

The iObjDefEntity is a programmatic case of an interface 66m. It is implemented by all objects within the ObjDef component 20 to allow all ObjDef objects 74 to be used interchangeably for selected purposes. It is not available in the ObjDef version 20a of the code. The iObjDefEntity has ID and ObjDef properties, as well as a ClassName property that returns a string value representing the name of the programmatic object (class).

A login 76m is a single set of application security login parameter values. The logins 76m are used to implement security access levels to data within a DMS 10. In addition to the properties inherited through the iObjDefEntity, the login 76m has dirty and ID properties and an update method. It further has a GroupID property to contain the identifier for the user group 70m to which it belongs, and a LoginName property to contain the user name associated with the definition of the login 76m.

The logins 76c is a collection class used to hold all of the definitions of the logins 76m within the ObjDef component 20. It has count, item, and NewEnum properties and add and remove methods.

The ObjDef object 74 is the primary class within the ObjDef component 20. It provides most of the functionality of the ObjDef component 20 as well as access to the various definitions of objects within the ObjDef component 20.

This key object has the following properties. An admin property returns an ObjectDefAdmin 78 object which is used to hold information on the version of ObjDef component 20 for which the currently selected ObjDef database 24 is configured. An AppDefDBFile property returns the name of the ObjDef database 24 file. This property is only used for File Server databases (Microsoft ACCESS, DBASE, etc.). A connection property returns an ADODB connection to the ObjDef database 24. A DataStores property returns a data stores 52c collection containing all of the data stores 52m objects defined in the ObjDef database 24. A LookupLists property returns a data objects 56c collection containing all of the data objects 56m defined in the ObjDef database 24 as lookup lists 68. A modules property returns a modules 54c collection containing all of the modules 54m defined in the ObjDef database 24. An objects property returns a data objects 56c collection containing all of the data objects 56m defined in the ObjDef database 24 as ObjectType. See e.g., the ObjectType values in FIG. 4. A provider property returns the information used to identify the database engine used to access the ObjDef database 24. (This is important when performing functions whose syntax vary between providers.) A relationships property returns a relates 80c collection containing all relates 80m defined in the ObjDef database 24. A reports property returns a report templates 60c collection containing all of the report templates 60m defined in the ObjDef database 24. A server property returns the name of the server that is hosting the ObjDef database 24. This property is only used for client-server databases (SQL SERVER, ORACLE, DB2, etc.). And a UserGroups property returns a user groups 70c collection containing all of the user groups 70m defined in the ObjDef database 24.

The ObjDef object 74 has the following methods. A CloseAppDef method closes the ObjDef database 24 and clears memory. A CreateDB method creates a new ObjDef database 24. New ObjDef databases are created with all of the necessary storage structures needed to be fully functional. All of the tables are empty until the user begins to create and save definition objects. An OpenDB method opens an existing ObjDef database 24. And a WhereUsed method returns a collection containing references to all definition objects that refer to a specified definition object. The specified object can be a data object 56m, a relate 80m, a data property 58m, a module 54m, a business rule 64m, or a report template 60m. When making changes to definitions, it is often necessary to identify all places where a definition is used so that the impact of the change can be evaluated and mitigated if necessary.

An ObjectModule 82m is used to hold the relationship between a data object 56m and a module 54m. A module 54m can have many data objects 56m. Similarly, a data object 56m can be in many modules 54m. The ObjectModule 82m includes a dirty property, a module property to return a module 54m associated with one half of the ObjectModule 82m pairing, and an ObjectRef property to return a data object 56m associated with one half of the ObjectModule 82m pairing.

The ObjectModules 82c is a collection class used to hold all of the definitions of the ObjectModules 82m within the ObjDef component 20. It has count, item, and NewEnum properties and add and remove methods.

The ObjRelationship 62m holds all of the information associated with the definition of a relationship between two data objects 56m in one direction. Two ObjRelationships 62m together form the complete, bi-directional, relationship defined by the relate 80m.

The ObjRelationship 62m has archive, broken, ID property, and ObjDef properties. It further has these properties. A broken property returns a Boolean value indicating whether the ObjRelationship 62m under discussion is broken. A broken ObjRelationship 62m is any in which a referenced data object 56m or data property 58m is missing. A dependency property returns a value that represents the dependency between the data objects 56m in the ObjRelationship 62m as seen in the current direction (starting object to target object). A FKProperty property returns a data property 58m that is the foreign key used in the ObjRelationship 62m. A JoinObject property returns a data object 56m that correlates to the join table used in the ObjRelationship 62m. A LinkLabel property returns a string value that is the label used to represent the data property 58m that holds the related data items (target objects) within the starting object. An ObjectName property returns a string value representing the name of the starting data object 56m associated with this definition of the ObjRelationship 62m. An ObjectReturnProperty property returns a string value representing the name of the data property 58m that is expected to be returned from the target data objects 56 through the ObjRelationship 62m. An OtherObjectPropertyName property returns a string value representing the name of a data property 58m within the target data objects 56 that holds the reference to the starting data object 56m. A ParentObject property returns a data object 56m that is the starting data object 56m defined for this half of the ObjRelationship 62m. A PropertyName property returns a string value representing the name of a data property 58m used to hold the related data items within the starting data object 56. A RelatedLink Property returns the ObjRelationship 62m that is the reverse of the current ObjRelationship 62m. A RelatedLinkID property returns a string value that is the ID of the ObjRelationship 62m for the other direction. A RelationshipName property returns a string value that is the name of the relate 80m used to create the ObjRelationship 62m. This value is the same for both data objects 56m in the ObjRelationship 62m, regardless of direction. A RelationshipType property returns a value that represents the type of ObjRelationship 62m between the data objects 56m as viewed from the current direction. See e.g., the RelateTypeEnum values in FIG. 4.

The ObjRelationships 62c is a collection class used to hold multiple ObjRelationship 62m definitions within the ObjDef component 20. This may hold two ObjRelationships 62m associated with a relate 80m or all ObjRelationships 62m in the system. It has count, item, and NewEnum properties.

A permission 72m is used to hold permission settings (managed as a binary sum) associated with a specific data object 56m and a specific user group 70m. A data object 56m will have a collection of permissions 72c associated with all of the defined user groups 70m. Similarly, a user group 70m will have a set of permissions 72m associated with all of the data objects 56m defined in the DMS 10.

In addition to the properties inherited through the iObjDefEntity 66a, a permission 72m has dirty and ObjectRef properties and delete and update methods. It further has these properties. A permission property returns a value that represents the permissions 72m associated with the specified data object 56m and user group 70m. See e.g., the ObjectPermissionEnum values in FIG. 4. A UserGroup property returns the user group 70m to which the permission 72m applies.

The permissions 72c is a collection used to hold all of the definitions of permissions 72m for a specific data object 56m or user group 70m. It has count and item properties.

The interface 66m is an object definition used to implement inheritance within the DMS 10. One or more data objects 56m can support an interface 66m by establishing a mapping between the properties of the interface 66m and the relevant properties of the data object 56m.

As an example, an interface 66m called “Person” might be developed for a system that manages different data objects 56m for “Clients,” “Staff,” and “Vendors.” Each of the data objects 56m has properties such as “Name,” “Address,” “City,” “State,” and “Zip Code” as well as various properties that are different between each data object 56m. Thus, the interface 66m would have properties called “Name,” “Address,” “City,” “State,” and “Zip Code” that are mapped to their corresponding properties in each of the data objects 56m.

An interface 66m has an archive property and these other properties. An InterfaceName property returns a string value that is the name of the interface 66m. A ParentObject property returns a data object 56m that is implementing the interface 66m. A properties property returns an InterfacePropertyMaps 84c collection that holds all InterfacePropertyMap 84m objects that define the property mappings between the interface 66m and a data object 56m that supports it.

The interfaces 66c is a collection class used to hold all of the definitions of interfaces 66m within the ObjDef component 20. It has count, item, and NewEnum properties and add and remove methods.

The InterfacePropertyMap 84m is an object that defines the mapping between a property of a specific data object 56m and a property of an interface 66m. It has archive and dirty properties as well as these other properties. A HostObjectRef property returns the data object 56m associated with the ObjectPropertyName property in this definition of the InterfacePropertyMap 84m. An InterfaceObjectRef property returns the interface 66m associated with the InterfacePropertyName property. An InterfacePropertyName property returns a string value that is the name of the property in the interface 66m that is being mapped in the InterfacePropertyMap 84m. And an ObjectPropertyName property returns a string value that is the name of the property in the data object 56m that is being mapped in the InterfacePropertyMap 84m.

The InterfacePropertyMaps 84c is a collection used to hold all of the definitions of InterfacePropertyMaps 84m for a specific data object 56m to interface 66m mapping. It has count, item, and NewEnum properties.

A module 54m is a definition of a functional grouping of definitions of data objects 56m based on business process. A single data object 56m may be part of multiple modules 54m.

In addition to the properties inherited through the iObjDefEntity 66a, a module 54m has description, dirty, and ID properties and an update method. It further has these properties. An installed property returns or sets a value indicating whether the module 54m is enabled for use by client applications 16. A ModuleName property returns a string value that is the name of the module 54m. And an objects property returns an ObjectModules 82c collection of all of the ObjectModules 82m that are included as part of the definition of the module 54m.

The modules 54c is a collection used to hold all of the definitions of modules 54m within the ObjDef component 20. It has count, item, and NewEnum properties and add and remove methods.

The data object 56m is the central element around which the DMS 10 is designed. It defines a data management structure to hold the different types of data managed by the DMS 10.

In addition to the properties inherited through the iObjDefEntity 66a, the data object 56m has archive, description, dirty, ID, and ObjDef properties and delete and update methods. It further has these properties. An AllowedPermissions property holds a value (managed as a binary sum) that represents the actions allowable on the data object 56m, irrespective of permission settings. See e.g., the ObjectPermissionEnum values in FIG. 4. A DataStore property holds the data store 52m that corresponds to the location of the data source 14 in which the data for the data object 56m is stored. A DefaultSort property contains a string value that corresponds to the name of the property that will be used, as a default, to sort any list of data objects 56m of the designated type. A DefaultText property contains a string value that corresponds to the name of the property that will be used, as a default, as the descriptive text in any list of data objects 56m of the designated type. An IDField property contains the name of the property that corresponds to the unique identification field for data associated with the type of the data object 56m. A modules property returns an ObjectModules 82c collection of ObjectModules 82m that identify the modules 54m in which the selected data object 56m is included. An ObjectLabel property contains a string value that is the user-friendly label for the data object 56m. An ObjectName property contains a string value that is the name of the data object 56m. An ObjectTypeCodes property holds a value that represents the functional roles for the data object 56m. The data objects 56m can fulfill several roles within the DMS 10 as defined by the ObjectTypeEnum values (FIG. 4). A permissions property returns a permissions 72c collection of all of the permissions 72m that apply to the selected data object 56m. A properties property returns a data properties 58c collection of all of the data properties 58m managed by the selected data object 56m. An ObjectRelationships property returns a relationships 62c collection of all of the relationships 62m that apply to the selected data object 56m. A reports property returns a report templates 60c collection of all of the report templates 60m that apply to the selected data object 56m. A rules property returns a business rules 64c collection of all of the business rules 64m that apply to the selected data object 56m. A TableName property contains a string value that is the name of the database table within the data store 52m that holds that data for the data object 56m. A ToolsObjType property contains a string value that is the type of generic object instantiated within the ObjSvr component 22 and configured to the structure defined in the data object 56m and used to hold data in the ObjSvr component 22. The DMS 10 can work with a variety of different types of objects. All text-based data objects 56m are managed as a single object type within the ObjSvr component 22. Other types of data, such as graphic images, maps, files, multimedia (photos, videos, sound clips, etc.) are each managed as different types of objects because of their different needs and uses. Finally, a viewable property contains a value indicating if the data object 56m is a viewable object. Non-viewable objects may exist within the DMS 10 to assist in managing the data but are not intended for visibility within client applications 16.

The data objects 56c is a collection used to hold all of the definitions of the data objects 56m within the ObjDef component 20. It has count, item, and NewEnum properties and add and remove methods.

The data property 58m define data structures to hold individual data values within and Object.Property structure of the DMS 10. It also holds information necessary to move data between the Object.Property structure and the data sources 14 defined in the data stores 52m.

The data property 58m has description, dirty, and ID properties and an update method. It further has these properties. An AllowedPermissions property holds a value (managed as a binary sum) that represents the actions allowable on the data property 58m, irrespective of permission settings. See e.g., the ObjectPermissionEnum values in FIG. 4. A DataType property returns a string value indicating the type of data being stored in the data property 58m. A DefaultLabel property contains a string value that is the user-friendly label for the data property 58m. A LookupListName property contains a string value that is used to provide valid data values for the data property 58m. A LookupListType property holds a value that represents the type of lookup list that is associated with the data property 58m. See e.g., LookupListTypeEnum values in FIG. 4. An ObjectReturnProperty property contains a string value representing the name of the data property 58m in the related data object 56m that is expected to be returned as a default when requested. If the DataType property of the data property 58m is an object or collection, then this property holds a string value representing the name of the data property 58m in the related data object 56m or data objects 56c collection that is expected to be returned as a default when requested. For any other data type, this property will be empty. A ParentObject property returns the data object 56m that is the parent for the data property 58m. A PropertyName property contains a string value that is the name of the data property 58m. A ReturnClassName property contains a string value representing the name of the related data object 56m associated with the data property 58m. If the DataType property of the data property 58m is an object or collection, then this property holds a string value representing the name of the related data object 56m or data objects 56c collection. For any other data type, this property will be empty. A rules property returns a business rules 64c collection of all of the business rules 64m that apply to the selected data property 58m. A source property contains a string value that is the source of the data to be placed in the data property 58m. There are three possible source entries: the name of a field within the table identified for the data object 56m; an Object.Property referencing a property of a related object; or a concatenation of properties and fixed strings. A StringLength property contains a variant value that is the maximum number of characters for values in the data property 58m. Finally, an updateable property contains a value indicating whether the value of the data property 58m can be changed by a client application 16.

The data properties 58c is a collection used to hold all of the definitions of data properties 58m within the ObjDef component 20. It has count, item, and NewEnum properties and add and remove methods.

The relate 80m contains all of the information necessary to create the pair of bi-directional relationships 62m used by a data object 56m in the DMS 10. The relates 80m are stored in the ObjDef database 24 and are used to generate relationships 62m when the ObjDef component 20 is initiated. Unlike relationships 62m, the relate 80m makes no distinction between relationship 62m direction.

The relate 80m has archive, broken, dirty, and ID properties and delete and update methods. It further has these properties. A dependency property returns a value that represents the dependency between the data objects 56m in the relate 80m as defined in the ObjDef database 24 (Object 1 to Object 2). See e.g., DependencyTypeEnum values in FIG. 4. A FKeyProperty property returns a data property 58m that is the foreign key used in the relate 80m. A JoinObject property returns a data object 56m that corresponds to the join table used in the relate 80m. A Label1 property returns a string value that is the label used to represent the data property 58m in Object 1 that holds the related data items from Object 2. A Label 2 property returns a string value that is the label used to represent the data property 58m in Object 2 that holds the related data items from Object 1. A name property returns a string value that is the name of the relate 80m. An ObjectName1 property returns a string value representing the name of Object 1. An ObjectName2 property returns a string value representing the name of Object 2. A PropertyName1property returns a string value representing the name of the data property 58m in Object 1 that is used to hold the related data items from Object 2. A PropertyName2 property returns a string value representing the name of the data property 58m in Object 2 that is used to hold the related data items from Object 1. A RelationshipType property returns a value that represents the type of relationship between the objects (Object 1 to Object 2). See e.g., RelateTypeEnum values in FIG. 4. A ReturnProperty1 property returns a string value representing the name of the data property 58m from Object 2 that is expected to be returned to Object 1 through the relate 80m. And a ReturnProperty2 property returns a string value representing the name of the data property 58m from Object 1 that is expected to be returned to Object 2 through the relate 80m.

The relates 80c is a collection used to hold all of the definitions of relates 80m within the ObjDef component 20. It has count, item, and NewEnum properties. It further has a FindRelationship method to find a relationship based on a specified Object.Property, and a NewRelationship method to add members to the relates 80c collection.

The ReportProperty 86m object is used to hold information relevant to report templates 60m. A report template 60m holds a ReportProperties 86c collection containing one or more ReportProperties 86m. The information held in ReportProperties 86m provides setup and configuration specifications for the report template 60m.

The ReportProperty 86m has archive, dirty, and ID properties and an update method. It further has these properties. A ParentReport property returns the report template 60m to which the ReportProperty 86m is associated. A PropertyName property contains a string value that is the name of the ReportProperty 86m. A PropertyType property contains a string value that signifies the type of property data being held in the value property of the ReportProperty 86m. And a value property returns a string value that is the value assigned to the ReportProperty 86m.

The ReportProperties 86c is a collection used to hold all of the definitions of ReportProperties 86m associated with a report template 60m. It has count, item, and NewEnum properties and an add method.

The report template 60m is used to define templates for reports used by the DMS 10. These templates can be in a variety of formats depending on the specific reporting engine specified. The DMS 10 currently includes reporting engines designed to use Microsoft WORD templates and rich text files.

Regardless of the format, the templates include normal text combined with Object.Property tags designed for use by the DMS 10. When a template is opened, each of the Object.Property tags is replaced with appropriate values from the DMS 10 as specified in the Object.Property tag. The resulting report is then displayed by the DMS 10 in the format specified by the report template 60m.

The report template 60m has archive, description, dirty, and ID properties and an update method. It further has these properties. A ClassEngine property returns a string value that is the name of the reporting engine that is responsible for loading, processing, and displaying the report. A PrimaryObject property contains a string value that is the name of the data object 56m for which the report is designed. A properties property returns a ReportProperties 86c collection of all of the ReportProperties 86m that apply to the selected report template 60m. And a ReportName property contains a string value that is the name of the report template 60m.

The report templates 60c is a collection used to hold all of the definitions of report templates 60m within the ObjDef component 20 or associated with a single data object 56m. It has count, item, and NewEnum properties and an add method.

The business rule 64m is used to define business rules within the DMS 10. Business rules function by defining a trigger event, a trigger object or property, a target object or property, and a rule action.

The business rule 64m has archive, description, dirty, and ID properties and an update method. It further has these properties. An object property contains a string value that is the name of the data object 56m that the business rule 64m will be triggered on. A ParentObject property returns the data object 56m that is the parent for the business rule 64m. A property contains a string value that is the name of the data property 58m that the business rule 64m will be triggered on. A rule property contains a string value that is the rule that will be enforced when the business rule 64m is triggered. A summary property contains a string value that is a user-friendly summary of the business rule 64m that can be displayed in the client application 16 when the business rule 64m is violated. A trigger property contains a value that represents the event trigger for the business rule 64m. See e.g., the TriggerRuleEnum values in FIG. 4. Finally, a value property returns a String value that is the value assigned to the business rule 64m.

The business rules 64c is a collection used to hold all of the definitions of business rules 64m associated with a single data object 56m of data property 58m. It has count, item, and NewEnum properties and an add method.

The user group 70m is used to hold login and permission information for a group of users 32. In addition to the properties inherited through the iObjDefEntity 66a, the user group 70m has dirty, ID, name, and ObjDef properties and an update method. It further has these properties. A DefaultPermissions property returns a value (managed as a binary sum) that represents the default permissions associated with the user group 70m. See e.g., ObjectPermissionEnum values in FIG. 4. A logins property returns a logins 76c collection of all of the logins 76m that apply to the user group 70m. And a permissions property returns a permissions 72c collection of all of the permissions 72m that apply to the user group 70m.

The user groups 70c collection class is used to hold all of the definitions of user groups 70m within the ObjDef component 20. It has count, item, and NewEnum properties and add and remove methods.

FIG. 7 is a table of representative constants which may be used with the objects in FIG. 8 and FIGS. 9A-E. FIG. 8 is a schematic diagram depicting an overview the ObjSvr object model 100 for the ObjSvr component 22, while FIGS. 9A-E collectively depict the objects in the ObjSvr object model 100.

The ObjSvr component 22 works in conjunction with the ObjDef component 20 and the data sources 14 to perform all data retrieval and storage functions of the DMS 10. The ObjSvr component 22 also processes queries and enables cross-platform querying. Each of the classes within the ObjSvr component 22 is presented below.

The objects and collections described next generally have some or all of the following properties. An archive property returns a Boolean value indicating whether the object has been archived. A count property returns a value representing the number of members within the collection under discussion. A dirty property contains a value indicating whether the object under discussion has been changed since the last update. An ID property contains the unique identifier for the object under discussion. An item property returns a specific member of the collection under discussion, either by position or by key. A NewEnum property allows support for “For Each . . . Next” style loops through the members of a collection.

Similarly, the objects and collections described next generally have some or all of the following methods. An add method adds a member to a collection. A GetLastErrors method may be used to retrieve a collection of error messages. This method is intended to be used to return multiple error messages where multiple errors have occurred. The ObjSvr component 22 is designed to process commands and check for all errors possible before posting an error to the operating system. A remove method removes a member from a collection. And a sort method returns another object containing all elements of the present one sorted by the properties identified in the method call.

The ObjectServer 102 is the primary class within the ObjSvr component 22. It provides most of the functionality of the ObjSvr component 22 as well as read-only access to various definition collection objects within the ObjDef component 20. The ObjectServer 102 has an item property and a GetLastErrors method.

The ObjectServer 102 additionally has these properties. A Lookups Property returns a LookupList 104 object containing a list of lookup values in an ADODBRecordset. A ObjectDefs property returns an ObjectDefs 106c collection that contains an ObjectDef 106m for each data object 56m defined in the ObjDef component 20. An ObjectGroups property returns an ObjectGroups 108c collection containing an ObjectGroup 108m object for each module 54m defined in the ObjDef component 20. A ReportDefs property returns a ReportDefs 110c collection containing a ReportDefs 110m for each report template 60 defined in the ObjDef component 20.

The ObjectServer 102 additionally has these methods. An AdHocQuery method returns an ADODB recordset based on the provided QueryDef 112.This method is used to generate an ADODB recordset containing data based on a provided QueryDef 112. A CreateDocument method initiates the creation of a report based on the values of the parameters collection passed and the data held in a passed ObjectData 114 object. This method is used to initiate the generation of a report and provide sufficient information to the RptGen component 30 to populate the report. Values held in the parameters collection are defined by the RptGen component 30 associated with the report. Information needed to populate these parameters is held in the definition of the report in the ReportDef 110m. An open method opens the specified ObjDef database 24. An ObjDef database 24 must be opened prior to execution of any methods or retrieval of any properties of the ObjectServer 102. Failure to do so will result in generation of errors. A search method returns a CollectionData 116 object containing a collection of the ObjectData 114 objects, based on the query definition information specified in the QueryDef 112. Execution of this method without a QueryDef 112 or with an incomplete one will result in errors.

A clsList 118 is used to hold a recordset derived from a query processed by the DMS 10. The clsList 118 holds the returned data in an ADODB recordset and also holds additional metadata about the query.

The clsList 118 has count and item properties, GetLastErrors and sort methods, and these other properties and methods. A dataset property returns an ADODB recordset containing the results of the requested query. A definition property returns a QueryDef 112 that corresponds to the query definition used to create the current clsList 118. An ObjectName property contains the name of the data object 56m associated with the clsList 118. A SelectedItems property contains an ObjectBag 120c that contains references to all of the items selected within the clsList 118. A SelectedRecord property sets or returns a Boolean value indicating if the designated record has been selected by the client application 16. This property is used to maintain the selection state of the recordset. The clsLists 118 are often used to populate lists in client applications 16. These lists may allow selection of multiple records. The selection state is therefore maintained in the SelectedRecord property of the clsList 118. A filter method returns another clsList 118 containing a subset of the data objects 56 in the current clsList 118, filtered by the QueryWhereConditions 124m identified in the method call. A PropertyValues method returns an ADODB recordset containing records for all of the data objects 56 in the clsList 118. Only a subset of the properties are included as requested in the method call. This method is used to retrieve a clsList 118 containing one or more references to data object 56 corresponding to related data as defined by the property provided in the method call. A RelatedData method returns another clsList 118 containing the related data objects 56 based on the relationship associated with the specified property.

An IToolsListItem holds four specific pieces of information for a single record within a clsList 118. The ObjectData 114 object contains all of the data associated with a specific record for a data object 56. The structure of the ObjectData 114 is defined by a corresponding data object 56. Because it takes time to instantiate and populate a ObjectData 114 (especially if it has many properties to populate), an abbreviated version (the IToolsListItem object) may be used for some purposes. When generating a list of ObjectData 114, each is instantiated and populated as an IToolsListItem that contain only four pieces of information. This can result in significant performance improvements in situations where the entire ObjectData 114 itself is not needed.

The IToolsListItem has archive and ID properties. It further has these properties. An ObjectName property returns a string value that is the name of the data object 56 that corresponds to the ObjectData 114 and the IToolsListItem. A text property returns a string value that is the text description of the ObjectData 114. This text property would be used by client applications 16 in any list of the items in a clsList 118.

The LookupList 104 is an object used to hold an ADODB recordset containing all possible values for a specific lookup list. It has a RawData method that returns an ADODB recordset containing all list items for a specific LookupList 104.

The ObjectBagItem 120m holds the information necessary to identify a specific ObjectData 114. It is only used in association with an ObjectBag 120c and cannot be created as new. The ObjectBagItem 120m has an ID Property and an ObjectName Property that returns a value representing the name of the object referenced by the ObjectBagItem 120m.

The ObjectBag 120c collection holds a collection of ObjectBagItems 120m. The ObjectBag 120c has count, item, and NewEnum properties and add and remove methods.

The ObjectGroup 108m object contains ObjectDefs 106m associated with a module 54m. The ObjectDefs 106m can be part of multiple modules 54m. The ObjectGroup 108m has an ID Property. It also has a GroupName property that contains a string value that is the name of the module defined by an ObjectGroup 108m. Its objects property returns an ObjectDef 106m.

The ObjectGroups 108c collection is used to hold definitions of all of the ObjectGroups 108m within the ObjSvr component 22. It has count, item, and NewEnum properties

The QueryDef 112 object contains all of the parameters needed to define a query within the ObjSvr component 22. The QueryDef 112 is an object-oriented version of a Structured Query Language (SQL) definition. The QueryDefs 112 cannot be created outside the ObjSvr component 22. A basic QueryDef 112 is returned from various methods within the ObjSvr component 22 and can be altered by the addition of where conditions. Where conditions can be added through the AddWhereCondition method or through the separate creation of a QueryWhereCondition 124m and addition of this to the QueryWhereConditions 124c collection.

The QueryDef 112 has these properties and methods. A RootObject property returns a string value that is the name of the object type requested in the query. A SQLString property returns a string value that is the SQL equivalent to the QueryDef 112. An AddMainClause method may be used to modify different parts of the QueryDef 112. See e.g., SQLMainClause values in FIG. 7. The code value provided designates the portion to be modified. An AddWhereCondition method may be used to add a where condition to the QueryDef 112. See e.g., enmWhereOp values in FIG. 7. A WhereConditions method may be used to access the QueryWhereConditions 124m held in the QueryWhereConditions 124c collection.

The QueryWhereCondition 124m contains all of the parameters needed to define a where condition for use within a QueryDef 112. The QueryWhereCondition 124m is an object-oriented version of a where clause in Structured Query Language (SQL).

The QueryWhereCondition 124m has these properties and methods. An operator property returns an enmWhereOp value that is the type of operator for the where condition. See e.g., enmWhereOp values in FIG. 7. A PropertyName property returns a string value that is the name of the data property 58 for which the where condition is being set. A ValueCount property returns an integer value that is the number of values returned by the ValueArray method. A ValueArray method may be used to read the value or values set for the where condition. This will be a single value for QueryWhereConditions 124m with enmWhereOp values set to ttEquals, ttIsGreaterThan, ttIsGreaterThanOrEqual, ttIsLessThan, ttIsLessThanOrEqual, and ttLike. This will be two values for QueryWhereConditions 124m with enmWhereOp values set to ttBetweenDates. This will be at least one value for QueryWhereConditions 124m with enmWhereOp values set to ttInList. The ValueArray will be empty for QueryWhereConditions 124m with enmWhereOp values set to ttNull.

The CollectionData 116 object is used to hold a collection of data as ADODB recordsets or as instantiated ObjectData 114. This object is also used to perform data searches and filtering. It has count, item, and NewEnum properties, as well as add, GetLastErrors, sort methods and a Filter method that may be is used to return a new CollectionData 116 based on the current CollectionData 116 filtered by the collection of QuerywhereConditions 124m.

The ObjectData 114 object is used to hold an instantiation of a data object 56 defined for the DMS 10. The data objects 56 for all data object types are instantiated as ObjectData 114.

The ObjectData 114 has archive, dirty, and ID properties; it has GetLastErrors and update methods; and it also has these properties and methods. A BaseObjectName property returns a string value that is the name of the object type associated with the ObjectData 114. An ObjectAsInterface property returns the ObjectData 114 as an interface 66 of the designated type. Recall, the interfaces 66 are container objects used to support polymorphism within the DMS 10. Each object type in the system can support one or more interfaces 66, depending on the interface mappings established in the ObjDef component 20. The interfaces 66 are often used to allow objects of different types to function interchangeably. An ObjectDefinition property returns the ObjectDef 106m that defines the structure of the ObjectData 114. Because the data objects 56 supported by the DMS 10 will have different data properties 58, relationships 62, business rules 64, etc., each ObjectData 114 has an associated ObjectDef 106m that defines its structure. An ObjectName property returns the name of the object type associated with the ObjectData 114. This value is the same as would be returned by requesting the ObjectName property of the ObjectDefinition property of the ObjectData 114 (i.e., ObjectData.Objectdefinition.ObjectName). A purge property contains a Boolean value indicating whether the ObjectData 114 should be purged from the data source 14 on the next system cleanup. This contains a Boolean value indicating whether the ObjectData 114 has been marked for purging. The ObjectData 114 marked for purging are not removed from the data source 14 until a system administrator conducts a database cleanup. Once marked for purging, the ObjectData 114 can be unmarked if the cleanup has not already been done. A text property returns the default text string that represents the contents of the ObjectData 114. This value is a property or concatenation of properties that is intended to be a unique identifier for the ObjectData 114. The text property is defined in the ObjDef component 20. A LookupList method may be used to retrieve a LookupList 104 for a designated property of the ObjectData 114. The lookup list is defined in the ObjectDef 106m. A properties method may be used to retrieve a properties 126c collection of PropertyData 126m objects that hold the data associated with the ObjectData 114. One PropertyData 126m is held for each property of the ObjectData 114. A reports method may be used to retrieve the ReportDefs 110c collection associated with the ObjectData 114. A requery method may be used to refresh the data in the ObjectData 114. This method is not available if the data in the ObjectData 114 has been changed and has not been saved. Finally, a ValidatePropertyValue method may be used to check the data in the ObjectData 114 against the business rules 64 associated with the ObjectDef 106m. See e.g., the ttRuleTrigger values in FIG. 7.

The ObjectDef 106m defines a data management structure to hold the different types of data managed by the DMS 10. The ObjectDef 106m has these properties. A label property returns a string value that is the user-friendly label for the ObjectDef 106m. An ObjectName property returns a string value that is the name of the ObjectDef 106m. An ObjectTypeCodes property holds a value that represents the functional roles for the ObjectDef 106m. The ObjectDefs 106m can fulfill several roles within the DMS 10, with specific roles defined by the summation of ObjectTypeEnum values. See e.g., the ObjectTypeEnum values in FIG. 7. A ReportDefinitions property returns a ReportDefs 110c collection of all of the ReportDefs 110m that apply to the ObjectDef 106m. A viewable property contains a value indicating if the ObjectDef 106m is a viewable object. Non-viewable objects exist within the DMS 10 to assist in managing the data but are not intended for visibility within client applications 16.

The ObjectDefs 106c collection holds definitions of all of the ObjectDefs 106m within the ObjSvr component 22. It has count, item, and NewEnum properties.

The properties 126c collection used to hold all of the definitions of PropertyData 126m objects within the ObjSvr component 22. It has count, item, and NewEnum properties.

The PropertyData 126m object is used to hold a single property value associated with a ObjectData 114. It has a GetLastErrors method as well as these properties. An attributes property returns an integer value that is a binary sum of PropertyDataAttributeEnum values. See e.g., the PropertyDataAttributeEnum values in FIG. 7. A DataType property returns an integer value that corresponds to the type of data held in the PropertyData 126m. See e.g., the ttDataType values in FIG. 7. A PropertyDefinition property returns a PropertyDef 128m object that defines the structure of the PropertyData 126m. Because the data objects 56 supported by the DMS 10 will have different data properties 58, relationships 62, business rules 64, etc., each PropertyData 126m has an associated PropertyDef 128m that defines its structure. A PropertyName property returns a string value that is the name of the PropertyData 126m. A value property returns a variant value that is the value assigned to the PropertyData 126m. A validate method may be used to check the data in the PropertyData 126m object against the business rules 64 associated with the PropertyDef 128m. See e.g., the ttRuleTrigger values in FIG. 7. A DefaultLabel property returns a string value that is the user-friendly label for the property defined by the PropertyDef 128m. A PropertyName property returns a string value that is the name of the property defined by the PropertyDef 128m. A RelationshipDefinition property returns a RelationshipDef 130 object that defines the relationship associated with the object or collection data defined by the PropertyDef 128m. A ReturnClassName property returns a string value that is the name of the ObjectDef 106m held within the object or collection data defined by the PropertyDef 128m.

The PropertyDefs 128c collection holds definitions of all of the PropertyDefs 128m within the ObjSvr component 22. It has count, item, and NewEnum properties.

The RelationshipDef 130 holds basic information about a relationship between the ObjectDef 106m and a related ObjectDef 106m. It has these properties. A DefaultDisplayProperty property returns a string value representing the name of the PropertyData 126m that is expected to be returned from the related ObjectData 114 as a default. A DependencyType property returns a value that represents the dependency between the ObjectDefs 106m in the relationship 62 as seen in the current direction (starting object to target object). See e.g., the DependencyTypeEnum values in FIG. 7. An ObjectName property returns a string value representing the name of the related ObjectDef 106m in this RelationshipDef 130. A RelationshipType property returns a value that represents the type of relationship 62 between the ObjectDefs 106m as viewed from the current direction. See e.g., the RelationshipTypeEnum values in FIG. 7.

The ReportDef 110m is used to define the report templates 60 used by the DMS 10. The report templates 60 can be in a variety of formats depending on the specific reporting engine specified. Each template includes normal text combined with Object.Property tags designed for use by the DMS 10. When a template is opened, each of the Object.Property tags is replaced with appropriate values as specified in the Object.Property tag. The resulting report is then displayed by the DMS 10 in the format specified by the ReportDef 110m.

The ReportDef 110m has an ID property as well as these. A PrimaryObject property returns a string value that is the name of the ObjectDef 106m for which the report is designed. A ReportName property returns a string value that is the name of the ReportDef 110m.

The ReportDefs 110c collection holds definitions of all of the ReportDefs 110m within the ObjSvr component 22. It has count, item, and NewEnum properties.

The ObjMgr component 28 is a tool developed to facilitate the input and management of the object definition and metadata information that is key to the operation of the DMS 10. The inventors' current ObjMgr component 28 employs a Graphical User Interface (GUI) designed as a Multiple Document Interface (MDI). It provides a navigation capability to create definitions for and then work with the data sources 14, modules 54, data objects 56, data properties 58, relationships 62 business rules 64, interfaces 66, user groups 70, etc. This, current, ObjMgr component 28 incorporates validation logic to prevent invalid definition entry and to test for broken relationships.

The object definition and metadata information maintained in the ObjDef database 24 could be manually input and maintained, however, the object definition and metadata for even a simple data management system would quickly become complex. Accordingly, there are many variations of the ObjMgr component 28 that might be used with the inventive DMS 10.

The RptGen component 30 works in conjunction with the ObjSvr component 22 to generate reports requested by a client application 16. The RptGen component 30 is a collection of report generators specifically designed to work with the DMS 10. Additional report generators can thus be added, as long as they support the interface used by the DMS 10.

All of the report generators collectively forming the RptGen component 30 use a report template 60 to define the layout of a report. Embedded within each report template 60 are Object.Property codes that signify the specific data elements to be placed into the report. When a report is generated, the Object.Property tags are replaced with data values from the data objects 56 supplied to the RptGen component 30. The report template 60 can, for example, be stored as MS Word document templates (*.dot), ASCII text files (*.txt), Rich Text Files (*.rtf), or a rich text within a database field. As is the case with the ObjMgr component 28, the report template 60 is optional, and when this utility is provided that may be by applying largely conventional concepts based on the already discussed details of the inventive DMS 10.

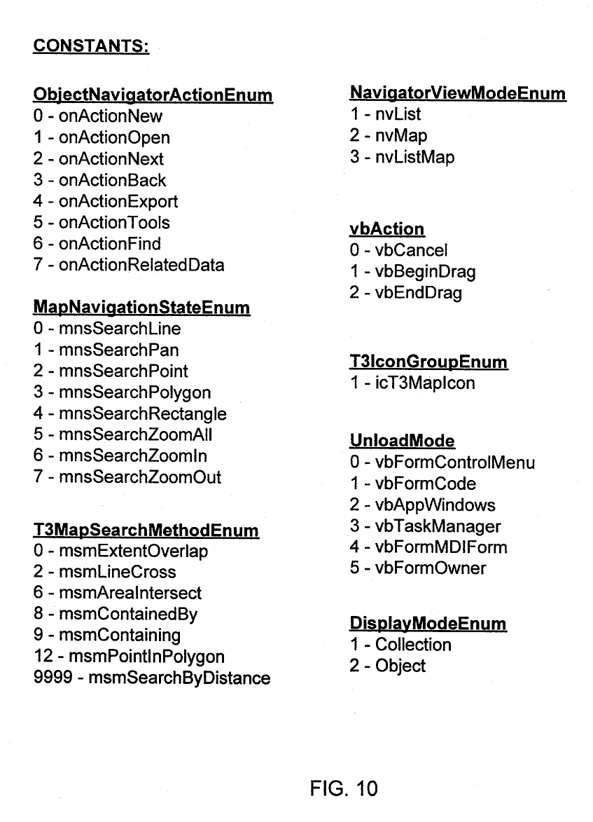

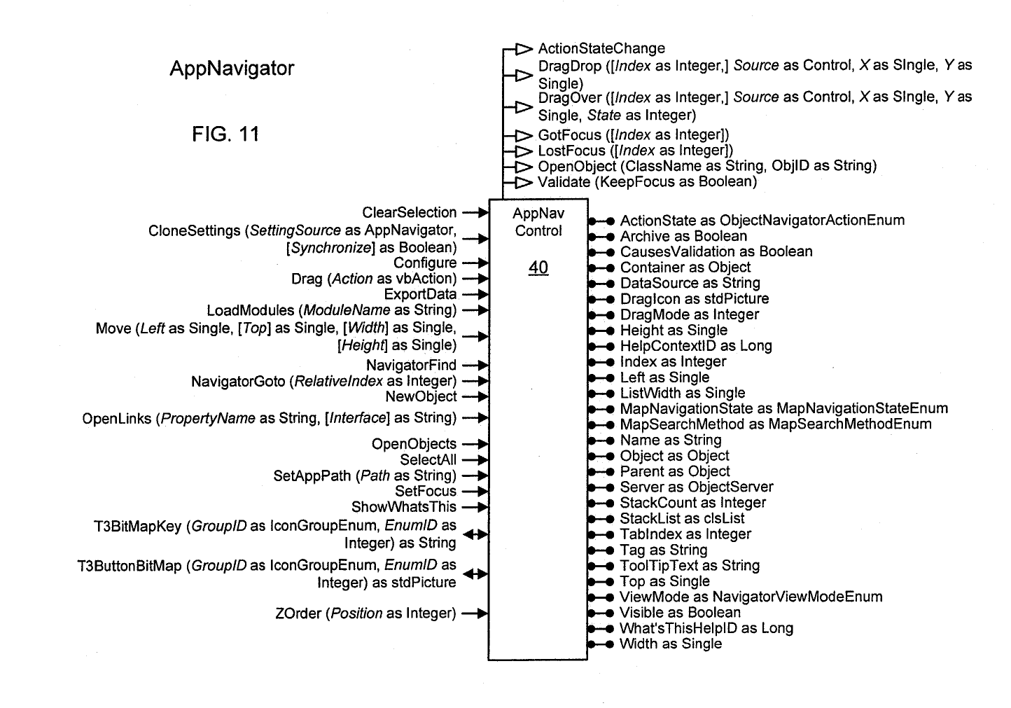

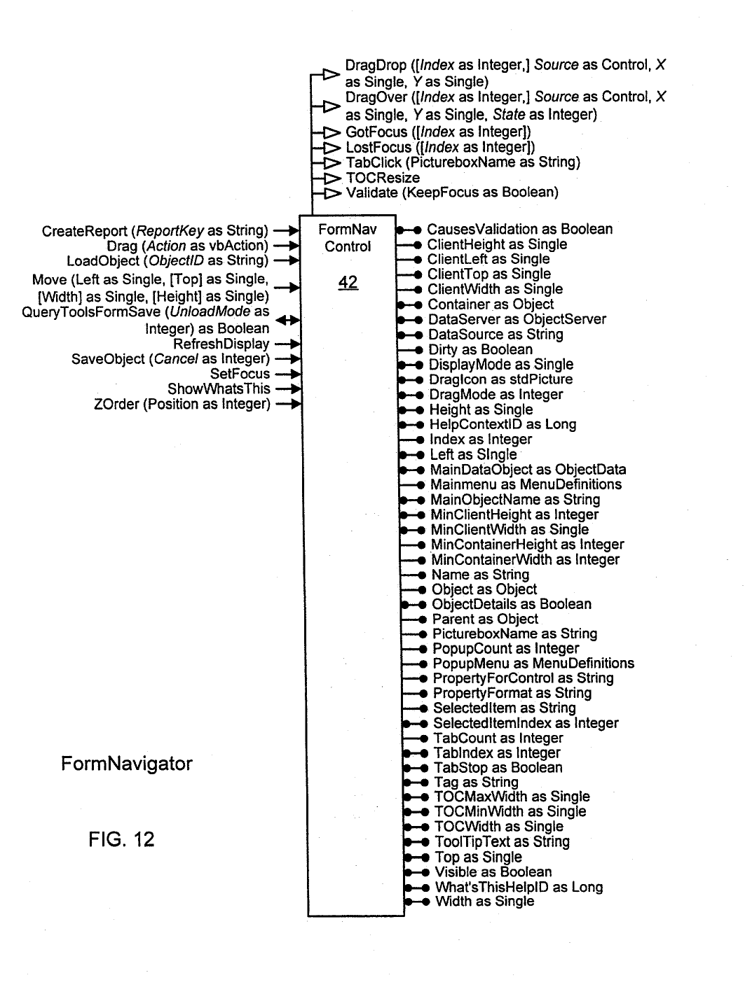

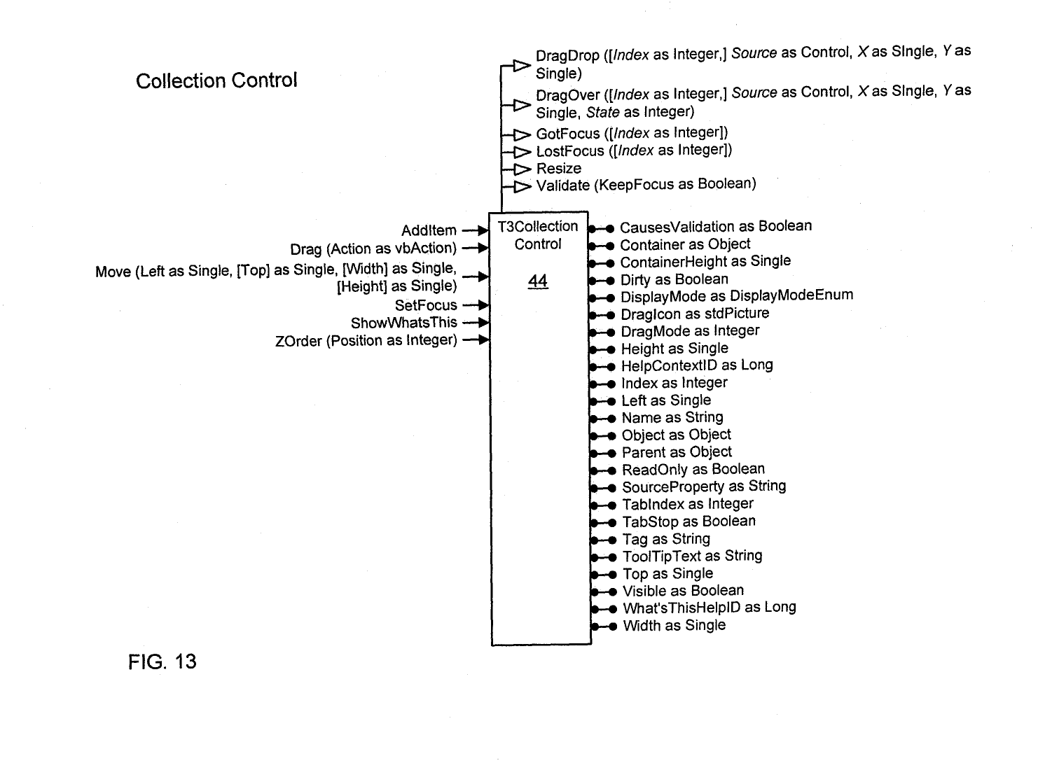

As noted above, the based controls 34 are also optional utilities that work with the client applications 16 to particularly access additional capabilities which the DMS 10 provides. The examples, shown in FIG. 1 and in FIGS. 10-13 are an AppNavigator 40 (application navigator), FormNav 42 (form navigator), and CollCtrl 44 (collection component). FIG. 10 is a table of the constants which are used in the inventor's current implementations of the based controls 34. FIG. 11 depicts the current AppNavigator 40; FIG. 12 depicts the current FormNav 42; and FIG. 13 is depicts the current CollCtrl 44. When these utilities are provided, they also may be largely conventional extensions of the already discussed details of the inventive DMS 10.

While various embodiments have been described above, it should be understood that they have been presented by way of example only, and not limitation. Thus, the breadth and scope of the invention should not be limited by any of the above described exemplary embodiments, but should be defined only in accordance with the following claims and their equivalents.

### Industrial Applicability

The present invention is well suited for application as an object relational database management system (DMS). It may be implemented as an object-oriented data management environment that provides a unified system for accessing data across multiple relational and non-relational data sources. The specific details of data storage are handled within the DMS 10 and are then invisible to the client application 16.

The DMS 10 was originally created to facilitate rapid development of applications that were primarily associated with data management. In developing a data management system, the vast majority of the programming effort is directly associated with moving data into and out of a database and into and out of controls on forms. The DMS 10 was designed to generically encapsulate this functionality and eliminate the time and effort associated with developing this code. Thus, the time needed to develop a data management application using the DMS 10 is greatly reduced.

Another effect of using the DMS 10 is the shifting of effort from implementation back into the design. The DMS 10 relies on the developer 38 designing a complete object model for the resulting application before any code is written. Because of the time required to do traditional coding of data management systems, the time spent in design has often been quite limited. The DMS 10 allows the developer more time to develop a robust and effective data model. In addition, any desired changes to the data model can quickly be made within the DMS 10, often without revising any associated code.

Although users 32 frequently request assistance in the development of decision support tools, evaluation of user needs generally has identified a more critical need for improved information management. Implementation of decision support tools or other data dependant systems relies on the availability of data. This availability is a direct function of the information management systems.

The DMS 10 was also designed to provide better documentation of the data model (metadata) for a client application 16. Data model metadata in traditional data management systems is usually limited to implicit documentation associated with the table and field structure of the database storage and limited comments placed in the program code during development. In some cases, an external data model document is produced at the time of system design. The definition of the data object model in the ObjDef database 24 within the DMS 10 explicitly documents the data model. In addition, every data object 56, data property 58, relationship 62, business rule 64, etc., includes a description field for additional documentation. Because this documentation is explicitly included in the development of the ObjDef database 24, the documentation is always current and is never separated from the DMS 10 it is documenting. This also means that the documentation can be displayed within a client application 16, if desired.

A secondary benefit of this documentation in the ObjDef database 24 is the potential to exchange data between systems based on the metadata 26. The planned extension of the DMS 10 may be a data interchange module to send and receive data objects with other systems using XML. The object design metadata can be transferred using a standardized XML markup. Once the metadata 26 is decoded, the receiving system will know what the pending data stream will look like and can handle it accordingly. The DMS 10 may be built to simplify data management system development and to grow to include a wide variety of automation tools and data display functionality as well.

The inventive DMS 10 employs a data management architecture designed to separate data storage issues from user interface issues. Data is stored in relational databases using existing relational database engines (e.g., Oracle, SQL Server, DB2, MS Access, etc.). The DMS 10 creates a middle layer or tier that organizes the data into business objects that are used by front-end applications. Business objects more accurately reflect the way a user thinks of data and thus corresponds more closely with the way the user interface is developed. The DMS 10 also eliminates the need for application developers to understand how and where the data is stored and to code SQL queries to retrieve the data in a format that can be linked to the front-end application.

The DMS 10 has many important features that, without limitation, include: facilitating object-based applications development, the use of virtual objects, true three-tier development, database independence, cross-platform data integration, flexible relational integrity, simplified data maintenance, modular legacy migration, a powerful business rules architecture, and interface objects to provide inheritance.

The DMS 10 facilitates object-based applications development because it separates how data is stored from how it is used. The developers 38 of client applications 16 can now develop systems that more closely match the business objects and business processes defined by the users 32 of those client applications 16. The invention uses a true object oriented architecture wherein the developers 38 may make use of object.property syntax to code the client applications 16. Properties of related data objects are similarly accessed by object.property.property wherein the first property is a related object and the second property is a property of that related object (example: Person.Organization.OrganizationName).

Traditional object oriented development involves developing, in code, object structures to retrieve, hold, and save data in a relational database. Incorporation of new objects involves additional coding in the middle layer. The DMS 10 need have no business specific objects, rather, it can use virtual objects. All objects may be created in memory as they are needed, based on object definition data stored in an ObjDef database 24. The DMS 10, without the ObjDef database 24, has no knowledge of business objects or data storage. That information is all provided by the ObjDef database 24 as the invention executes. Thus, to add new objects to the DMS 10, a developer 38 adds new data to the ObjDef database 24 and those objects become available to the client applications 16.

Most three-tier applications are direct descendants of two-tier applications. An object layer is constructed between the user application and the database in such a way that the objects and properties match the structure of how the data is stored. The DMS 10 has a middle tier that is completely independent of the data sources 14 and allows objects to be constructed any way desired, regardless of the nature of the data sources 14. The DMS 10 thus permits true three-tier development.

The DMS 10 makes us of ActiveX Data Objects (ADO) to communicate with database servers that provide data storage. Thus, any database system that supports Open Database Connectivity (ODBC) can be accessed by the DMS 10, and this permits database independence.

Because the DMS 10 constructs data objects that are independent of the data sources 14, the invention can permit cross-platform data integration, and can create objects that include information stored in multiple databases that may be on multiple platforms (e.g., Oracle, SQL Server, DB2, etc.). In addition, if one data source is off-line or unavailable, the system will provide objects with whatever property data is available and will provide missing property data if and when it becomes available.

Traditional databases include relational integrity rules maintained and enforced by the database server engines. Because the DMS 10 integrates data across multiple data storage platforms (i.e., multiple, potentially different data sources 14), issues of data integrity are meaningless with respect to the database engines themselves. The DMS 10 relies on relational integrity rules administered in the middle layer independent of the data storage systems. This allows relational integrity to become highly flexible and customizable. This architecture allows for parameterized relational integrity rules. For example: a relational integrity rule can be established between a person record stored in one database and related organization records maintained in two or more other databases on one or more platforms. This allows the DMS 10 to work with data that is stored in multiple systems without migrating the data.

The DMS 10 includes tools for simplified data maintenance, such as creating, editing, and deleting objects. It also includes tools for creating and modifying its ObjDef database 24, on various platforms as needed. If desired, the DMS 10 creates SQL Script to perform structural modifications on the ObjDef database 24 that reflect the corresponding changes to object definitions.

As previously noted, the ability to work with multiple databases on multiple platforms allows data to be move around independent from the client applications 16. Using the DMS 10, legacy systems can thus be maintained concurrent with new systems until those new systems are accepted. Similarly, data can be moved from one data source 14 to another or from one platform to another without affecting the client applications 16. In sum, this permits modular legacy migration.

Because the DMS 10 does not rely on business rules enforced at the data source 14 (database) level, it is not limited to the types of business rules allowable within conventional databases. A range of business rules may be built into the DMS 10 and can be used as needed. If the existing rules are not sufficient, new rules can be created (e.g., as COM objects) following simple architecture rules and then will be available for use in the DMS 10. This allows developers 38 to create any type of business rule needed for a specific application. In addition, because all business rules are stored in the application definition database, they can be added, changed, or removed as desired without changing anything in either the data sources 14 or the client applications 16.

It is quite common for systems to make use of multiple data objects that are similar but not the same. The objects would have some properties in common (although they may not be identified by the same property name). The inventive DMS 10 allows developers 38 using it to create interface objects that reflect the commonality of the objects. Properties in each of the objects are mapped to their corresponding properties in the interface object and thus can be seen as the same. This allows the developers 38 to create applications that work with the interface objects independent of the true objects. For example: If two databases (say, one SQL Server and one Oracle) contain tables of organization records, the DMS 10 would have two objects that corresponded to the Organizations in each of the databases (they may or may not have exactly the same properties). An interface object would then be used to retrieve a list of all organizations, regardless of which database they exist in. If a specific organization is selected, the interface object knows which object type that corresponds to, would open up the appropriate user interface for that object type, and retrieve the data for that object from the appropriate database (all independent of the client application 16).

For the above, and other, reasons, it is expected that the DMS 10 of the present invention will have widespread industrial applicability. Therefore, it is expected that the commercial utility of the present invention will be extensive and long lasting.

What is claimed is:

1. An object relational database management system for a client application to access data in at least one data source, comprising:
an object definition database, an object definition component, and an object server component, wherein:
said object definition database contains metadata, in the form of programmatic objects, about location and structure of the data in the data sources;
said object definition component reads said metadata from said object definition database and provides it to said object server component; and
said object server component manages data storage and retrieval functions in the data sources for the client application, based on said metadata.

2. The object relational database management system of claim 1, wherein said data sources include at least one member of the set consisting of open database connectivity (ODBC) compliant databases, geographic information system (GIS) data files, and multimedia files.

3. The object relational database management system of claim 1, wherein said object definition database is a relational type database, although said metadata is not necessarily relational.

4. The object relational database management system of claim 1, wherein said metadata includes data objects that logically represent physical or procedural objects related to business which the client application or data sources support and properties that define elements of the data associated with said data objects.

5. The object relational database management system of claim 4, wherein said metadata includes relationships that define properties and parameters that link two said data objects, either intra or inter the data sources.

6. The object relational database management system of claim 4, wherein said metadata includes modules that group said data objects together with functionalities for use by the client application.

7. The object relational database management system of claim 4, wherein said metadata includes interfaces that map to properties of one or more said data objects but not to actual said data objects, thereby providing inheritance and polymorphism while not holding or persisting instances of the data.

8. The object relational database management system of claim 1, wherein said metadata includes data stores that each define a distinct data source.

9. The object relational database management system of claim 1, wherein said metadata further includes organizations, relations, and rules of the data in the data sources for use by the client application.

10. The object relational database management system of claim 1, wherein said metadata includes business rules that define integrity of the data or business practices or processes using the data.

11. The object relational database management system of claim 1, wherein said metadata includes security information.

12. The object relational database management system of claim 11, wherein said security information includes user groups and permissions for members of user groups to access the data.

13. The object relational database management system of claim 1, wherein said object server component accepts requests for the data from the client application, determines where the requested data is in the data sources based on said metadata, determines any relationships between the requested data, determines a structure for the requested data suitable for use by the client application, obtains the requested data from the data sources, constructs a document object of the obtained data, and provides said document object to the client application.

14. The object relational database management system of claim 1, further comprising an object manager component to create and manage said metadata in said object definition database.

15. The object relational database management system of claim 14, wherein said object manager component provides a graphical user interface (GUI), thereby facilitating managing said metadata by a human user.

16. The object relational database management system of claim 15, wherein said object manager component further can create and manage the data sources.
